(19) United States
(12) Patent Application Publication
(10) Pub. No.: US 2003/0131111 A1
(43) Pub. Date: Jul. 10, 2003

(54) Information processing system, information processing apparatus and access distributing method

(75) Inventors: Yoshihiro Kimura, Kawasaki (JP); Hideki Ise, Kawasaki (JP); Akira Ohtsuka, Kawasaki (JP); Junichi Nagase, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/201,959

(22) Filed: Jul. 25, 2002

(30) Foreign Application Priority Data
Jan. 10, 2002 (JP) 2002-003538

(51) Int. Cl. G06F 15/16

(52) U.S. Cl. 709/228; 709/217

(57) ABSTRACT

A system in which clients send data transfer requests to a server, and the server transmits data to the clients according to the data transfer requests. In the system, the server includes an access management part that creates access information representing an access state of the clients based on the data transfer requests from the clients, and manages access by the clients to the server based on the access information.

### BACKGROUND OF THE INVENTION

1. Field of the Invention

The present invention relates to an access management system, apparatus and access distributing method, and more particularly, to a system that transmits data from a server to clients according to data transfer requests from the clients, an apparatus and access distributing method used in the system.

2. Description of the Related Art

FIG. 1 is a block diagram of a client/server system 1. In the client/server system 1, a plurality of clients 11-1 through 11-n can access a server 13 via a network 12 so as to obtain desired data. In such a system, there is a case where the clients 11-1 through 11-n regularly access the server 13 and obtain new data and programs so as to update current data and programs that the clients have. Conventionally, it has been possible for the clients 11-1 through 11-n to set access time by the clients to the server 13 in accordance with the operating time of the clients.

FIG. 2 is a schematic diagram showing operations of a conventional client/server system. FIG. 2-A corresponds to a case of an NG (negative, or no good) response, and FIG. 2-B corresponds to a case of an OK response.

First, a description will be given of the operation in the case of the NG response.

In step S1-1, a client 11-i of the clients 11-1 through 11-n sends a data request to the server 13. In step S1-2, the server 13 receives the data request, and determines whether or not it is possible to perform a data transfer. When it is impossible to perform the data transfer to the client 11-i since the server 13 is busy, in step S13, the server 13 transmits to the client 11-i an NG response.

In step S1-4, when the client 11-i receives the NG response from the server 13, the client 11-i waits until a definite time is counted. In step S1-5, the client 11-i performs the data request again after the definite time duration.

Next, a description will be given of the operation in the case of the OK response.

In step S1-11, the client 11-i of the clients 11-1 through 11-n sends a data request to the server 13. In step S1-12, when the server 13 receives the data request from the clients 11-i, the server 13 determines whether or not it is possible to perform the data transfer. When it is possible to perform the data transfer in step S1-12, in step S1-13, the server 13 transmits to the client 11-i an OK response. At the same time, the server 13 transmits the requested data to the client 11-i.

When the client 11-i receives the OK response and the requested data from the server 13, in step S1-14, the client 11-i provides the server 13 a completion report.

In this way, when the server 13 is busy, the client 11-i repeats sending the data request to the sever 13 at regular time intervals until the data transfer from the server 13 becomes possible.

Additionally, the clients 11-1 through 11n have functions with which an administrator can set the access time to the server 13.

However, there is a case where the server 13 temporarily exceeds its processing capacity when the administrator of the clients 11-1 through 11-n sets the access time, wherein the clients 11-1 through 11-n are operated in the same business hours, thus, a lot of accesses requests from the clients 11-1 through 11-n to the server 13 are concentrated. On the other hand, in a time frame having no access requests, the server 13 has free resources. In this way, there has been a problem in that the resources of the server are not effectively used.

Additionally, in a case where the server temporarily exceeds its processing capacity since access requests are concentrated at the server, as shown in FIG. 2A, the server transmits an NG response to a client so that the client performs retrying. Conventionally, the retrying has been performed at regular time intervals. Thus, when a state in which the access requests being concentrated at the server continues, in a case when a data request is retried, there is a possibility that the client receives the NG response again.

Further, the client that fortunately retries at the moment when the server has free resources receives service earlier than the client that has been retrying longer. Accordingly, there is a problem in that the service, such as the data transfer, becomes biased according to timing of the retrying of the client.

When a large amount of data is transferred between the clients and server, and the transfer is performed via the Internet, since the processing time of each of the clients becomes uncertain because usable bandwidth of the Internet is uncertain, there is a problem in that it is difficult to estimate load on the server.

In addition, there is a case where the clients cannot retry at the next retrying time or in the time frame for certain reasons though the server determines the next retrying time or time frame for the clients. Thus, there is a problem in that the server cannot simply notify the clients of a retrying time or time frame.

It is expected that the clients send the data transfer requests at the next access all together when data resources that are available in the server and are common to the clients are changed. In this case, conventionally, the load on the server has been estimated only from the number of clients. However, since each of the clients has a different processing capacity and a different communication band, the estimation tends to be unreliable in many cases. Thus, there is a problem in that the load on the server cannot be controlled.

### SUMMARY OF THE INVENTION

It is a general object of the present invention to provide an improved and useful system, apparatus and access distributing method in which the above-mentioned problems are eliminated.

A more specific object of the present invention is to provide a system, apparatus and access distributing method in which communication between a server and clients can be effectively performed.

In order to achieve the above-mentioned objects, there is provided according to one aspect of the present invention, a system in which clients send data transfer requests to a server, and the server transmits data to the clients according to the data transfer requests, wherein the server including an access management part that creates access information representing an access state of the clients based on the data transfer requests from the clients, and manages access by the clients to the server based on the access information.

According to the above-mentioned aspect of the present invention, by managing the access information of the clients, such as access time and process time, it is possible to estimate the end time for the next access.

In addition, the server may manage the number of times of accessing as the access information, and control permission of the access by the clients based on the number of times of requesting access.

Further, it is possible to prevent a certain client from waiting for service for an extremely long time by prioritizing requests by the clients according to the number of times of retrying from the clients.

Additionally, there is provided according to another aspect of the present invention, a system in which clients send data transfer requests to a server, and the server transmits data to the clients according to the data transfer requests, wherein the clients set at least next access time to time when access to the server has succeeded.

Further, there is provided according to another aspect of the present invention, an apparatus that sends a data transfer request to a server, and causes the server to transfer data corresponding to the data transfer request, including: an access management part that sets next access time to time when access to the server has succeeded.

According to the above-mentioned aspects of the present invention, each of the clients records time, when the request has succeeded, and accesses the server at the time thereof the next time. Thus, it is possible to distribute the load on the server, which is caused by the clients accessing the server.

Further, there is provided according to another aspect of the present invention, a system in which clients send data transfer requests to a server, and the server transmits data to the clients according to the data transfer requests, wherein the server selects a client to access, sets the access time of the client so as not to transmit an NG response, and notifies the client of the access time that is set, and the client accesses the server at the access time that is notified by the server.

According to the above mentioned aspect of the present invention, in a case where more clients than the number of the clients that the server can simultaneously handle access the server, the server estimates an end time for each of the clients based on the access information, and notifies each of the clients of the next retrying time with the NG response. Thus, it is possible to perform the load sharing of the server.

Additionally, there is provided according to another aspect of the present invention, an apparatus that transmits data to clients according to data transfer requests from the clients, including: an access management part that creates access information representing an access state of the clients based on the data transfer requests from the clients, and controls access by the clients so as to distribute the access by the clients based on the access information.

Additionally, there is provided according to another aspect of the present invention, an apparatus that transmits data to clients according to data transfer requests from the clients, including: an access management part that selects a client to which data transfer should be performed, sets the access time of the selected client so as not to transfer an NG response, and notifies the client of the access time that is set.

According to the above-mentioned aspects of the present invention, in a case where data of the server are updated, the server makes out a schedule of the data requests from the clients, and notifies the clients of the schedule. Therefore, it is possible to perform the load sharing of the server.

Additionally, there is provided according to another aspect of the present invention, an access distributing method of a system in which clients send data transfer requests to a server, and the server transmits data to the clients according to the data transfer requests, wherein access information representing an access state of the clients is created based on the data transfer requests from the clients, and access by the clients is controlled to be distributed based on the access information.

Further, there is provided according to another aspect of the present invention, an access distributing method of a system in which clients send data transfer requests to a server, and the server transmits data to the clients according to the data transfer requests, wherein time when access to the server has succeeded is set as next access time of the clients.

Additionally, there is provided according to another aspect of the present invention, an access distributing method of a system in which clients send data transfer requests to a server, and the server transmits data to the clients according to the data transfer requests, wherein the clients to which data transfer should be performed are selected, access time of the selected clients is set so as not to transfer NG responses, and the clients are notified of the access time that is set, and the clients are caused to access the server at the access time that is notified by the server.

Additionally, there is provided according to another aspect of the present invention, a method to be carried out by the operation of a server, including the steps of: causing the server to prepare access information representing an access state of clients based on data transfer requests from the clients; and controlling access by the clients so as to distribute the access by the clients based on the access information.

In addition, there is provided according to another aspect of the present invention, a method to be carried out by the operation of a server in a system in which clients send data transfer requests to a server, and the server transmits data to the clients according to the data transfer requests, wherein the time when access to the server has succeeded is set as the next access time of the clients.

Further, there is provided according to another aspect of the present invention, a method to be carried out by the operation of a server, including the steps of: selecting clients to which data transfer should be performed; setting access times of the selected clients so as not to transfer an NG response; and notifying the clients of the access times that are set.

According to the present invention, even in a case where the clients are connected to the server via an indeterminate network, such as the Internet, it is possible to estimate process time of each of the clients. Therefore, it is possible to notify the client of the most appropriate retrying time. As a result, it is possible to perform effective communication without adding extra load to both server and clients.

Further, in a case where it is estimated that the clients will request data transfer simultaneously, it is possible to positively perform control of the load of the server by estimating the end time for each of the clients and by changing the next access time of each of the clients according to directions from the server.

Other objects, features and advantages of the present invention will become more apparent from the following detailed description when read in conjunction with the following drawings.

### BRIEF DESCRIPTION OF THE DRAWINGS

FIG. 1 is a block diagram of a client/server system of a related art;

FIG. 2 is a schematic diagram for explaining operations of a conventional client/server system;

FIG. 3 is a block diagram of a first embodiment of the present invention;

FIG. 4 is a block diagram of a client 101i;

FIG. 5 is a block diagram of a server 102;

FIG. 6 is a schematic diagram of a management table in an access information storage area 124c;

FIG. 7 is another schematic diagram of the management table in the access information storage area 124c;

FIG. 8 is a flow chart for explaining end time estimation process;

FIG. 9 is a schematic diagram showing a sequence in a case of an NG response of the first embodiment of the present invention;

FIGS. 10A, 10B and 10C are schematic diagrams for explaining operations of a simultaneous connection management chain and free client management table chain;

FIG. 11 is a flow chart for explaining operations of the server 102 when clients perform requests in the first embodiment of the present invention;

FIG. 12 is a schematic diagram for explaining operations in a case of the NG response in the first embodiment of the present invention;

FIG. 13 is a block diagram of a client 101-i of a second embodiment of the present invention;

FIG. 14 is a flow chart for explaining a process of the client of the second embodiment of the present invention;

FIG. 15 is a block diagram of a server 102 of the second embodiment of the present invention;

FIG. 16 is a schematic diagram showing a structure of data in a client control area 201;

FIG. 17 is a flow chart for explaining a process of the server 102 of the second embodiment of the present invention;

FIG. 18 is a schematic diagram for explaining specific operations of the second embodiment of the present invention;

FIG. 19 is another schematic diagram for explaining the specific operations of the second embodiment of the present invention;

FIG. 20 is a block diagram of a client 101-i of a third embodiment of the present invention;

FIG. 21 is a flow chart for explaining a process of the client 101-i of the third embodiment of the present invention;

FIG. 22 is a schematic diagram for explaining a specific example of the third embodiment;

FIG. 23 is another schematic diagram for explaining the specific example of the third embodiment;

FIG. 24 is a flow chart for explaining a modification of a process of the client of the third embodiment of the present invention;

FIG. 25 is a schematic diagram for explaining an operation of the modification of the third embodiment of the present invention;

FIG. 26 is another schematic diagram for explaining the operation of the modification of the third embodiment of the present invention;

FIG. 27 is a block diagram of a server 102 of a fourth embodiment of the present invention;

FIG. 28 is a schematic diagram showing a structure of data in a schedule table management area 124g;

FIG. 29 is a flow chart for explaining a process of the fourth embodiment of the present invention;

FIG. 30 is a flow chart for explaining a process of calculating start time and end time of a client 101-i;

FIG. 31 is a schematic diagram showing next access time that is set to clients 101-1 through 101-n;

FIG. 32 is a schematic diagram showing a data structure of a management table 300; and

FIG. 33 is a schematic diagram showing a schedule table.

### DETAILED DESCRIPTION OF THE PREFERRED EMBODIMENTS

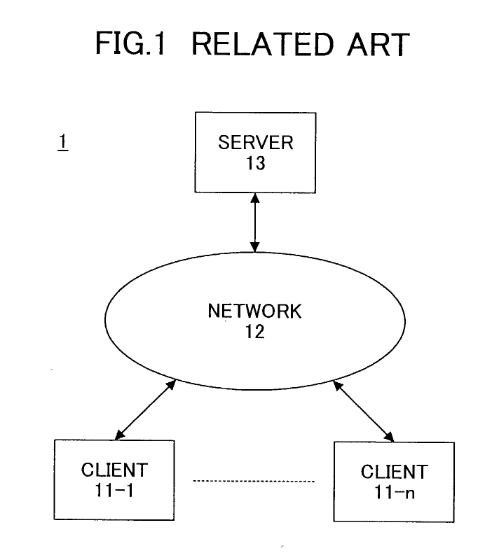

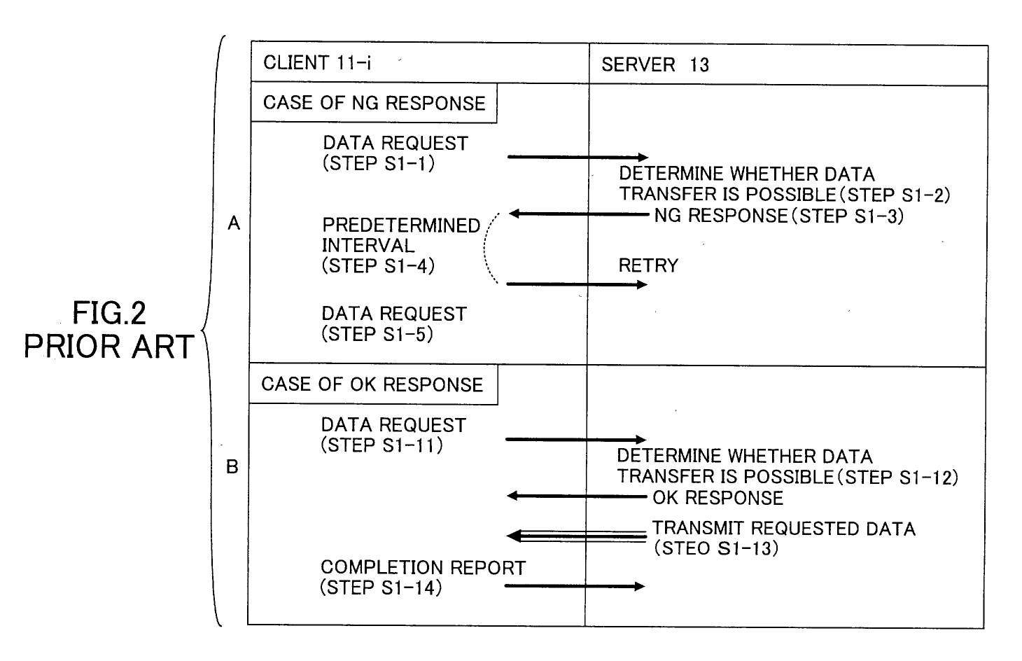

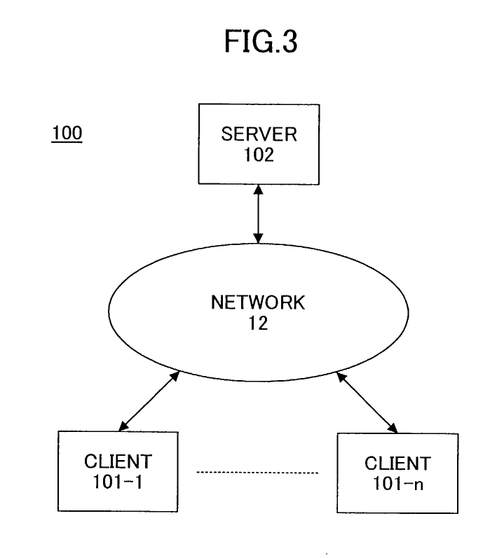

FIG. 3 is a block diagram of a first embodiment of the present invention. In FIG. 3, those parts that are the same as those corresponding parts in FIG. 1 are designated by the same reference numerals, and a description thereof will be omitted.

A system 100 of this embodiment is different from a conventional system in processes of clients 101-1 through 101-n and a server 102.

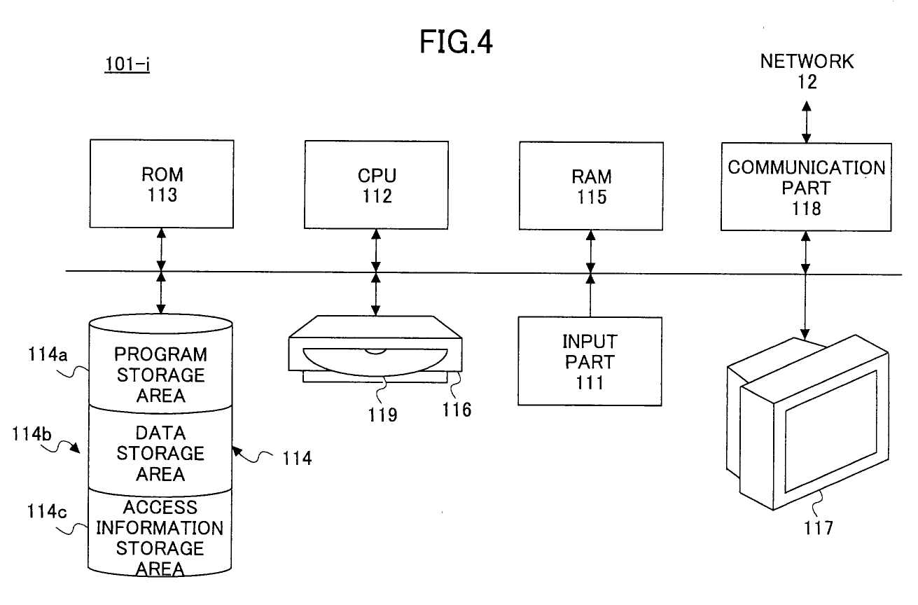

FIG. 4 is a block diagram of a client 101i. The client 101-i is a client of the clients 1011 through 101-n. The client 101-i includes an input part 111, a CPU (central processing unit) 112, a ROM (read only memory) 113, a hard disk drive 114, a RAM (random access memory) 115, a CD-ROM drive 116, a display part 117, and a communication part 118. The input part 111 includes a keyboard and a mouse, and is used for inputting data or commands. The CPU 112 performs various processes based on an OS (operating system), programs and data stored in the ROM 113 and hard disk drive 114.

The hard disk drive 114 includes a program storage area 114a, a data storage area 114b, and an access information storage area 114c. The program storage area 114a stores the OS and programs. The data storage area 114b stores various data. The access information storage area 114c stores access information such as next access time. Further, the RAM 115 is used as a working memory area for the CPU 112.

The CD-ROM drive 116 is an apparatus for reading data from a commutative recording medium such as a CD-ROM 119. For example, the program stored in the program storage area 114a of the hard disk drive 114 is provided as storage data on the CD-ROM 119, is read by the CD-ROM drive 116 from the CD-ROM 119, and is installed to the program storage area 114a of the hard disk drive 114. Further, the program stored in the program storage area 114a of the hard disk drive 114 may be obtained from another server via a network 12 using the communication part 118.

The display part 117 is structured by a CRT (cathode ray tube), LCD (liquid crystal display) or the like, and displays process data on a display screen. The communication part 118 communicates with the server 102 via the network 12.

Next, a description will be given of the structure of the server 102.

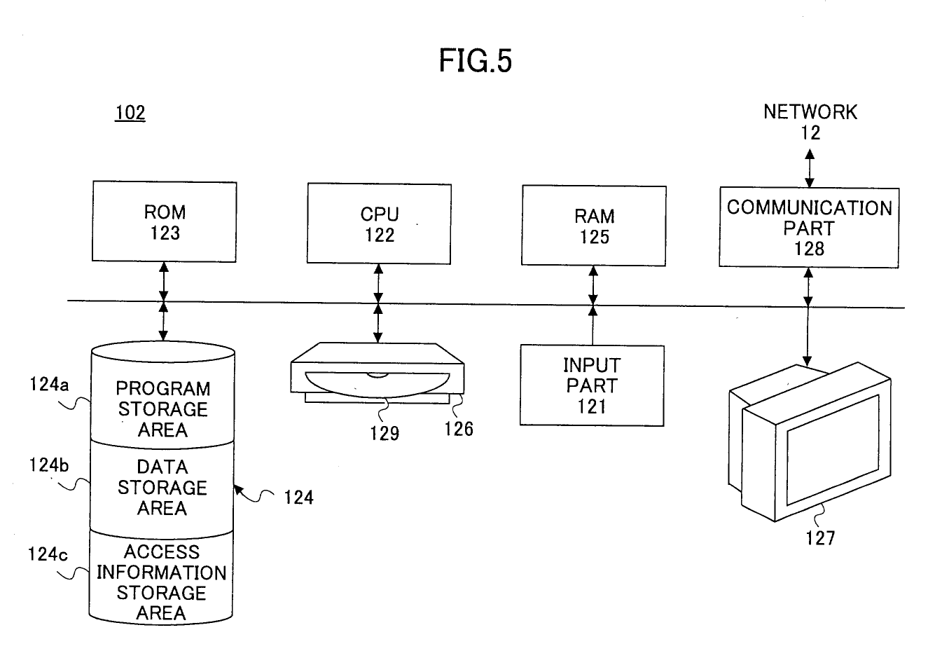

FIG. 5 is a block diagram of the server 102. The server 102 includes an input part 121, a CPU 122, a ROM 123, a hard disk drive 124, a RAM 125, a CD-ROM drive 126, a display part 127 and a communication part 128.

The input part 121 includes a keyboard and a mouse, and is used for inputting data or commands. The CPU 122 performs various processes based on an OS (operating system), programs and data stored in the ROM 123 and hard disk drive 124. The hard disk drive 124 includes a program storage area 124a, a data storage area 124b, and an access information storage area 124c. The program storage area 124a stores a transfer program that transfers data or programs from the data storage area 124b to the clients 101-1 through 101-n according to data requests from the clients 101-1 through 101-n, and an access information creating program that creates access information and stores the access information in the access information storage area 124c.

The access information storage area 124c stores management tables created by the access information creating program. Further, the RAM 125 is used as a working memory area for the CPU 122. The CD-ROM drive 126 is an apparatus that reads data from the commutative recording medium such as a CD-ROM 129. For example, programs stored in the program storage area 124a of the hard disk drive 124 are provided as storage data on the CD-ROM 129, are read by the CD-ROM drive 126 from the CD-ROM 129, and are installed to the program storage area 124a of the hard disk drive 124. Further, the programs stored in the program storage area 124a of the hard disk drive 124 may be obtained from another server via the network 12 using the communication part 128.

The display part 127 is structured by a CRT (cathode ray tube), an LCD (liquid crystal display) or the like, and displays process data on a display screen. The communication part 128 communicates with the clients 101-1 through 101-n via the network 12.

Additionally, in this embodiment, the server 102 stores access start time, end time, volume of data, process execution time and the like in the management tables in the access information storage area 124c as the access information, according to access requests from the clients 101-1 through 101-n using the programs stored in the program storage area 124a, and estimates the end times for the next accesses. The estimated end time is stored in the management tables in the access information storage area 124c.

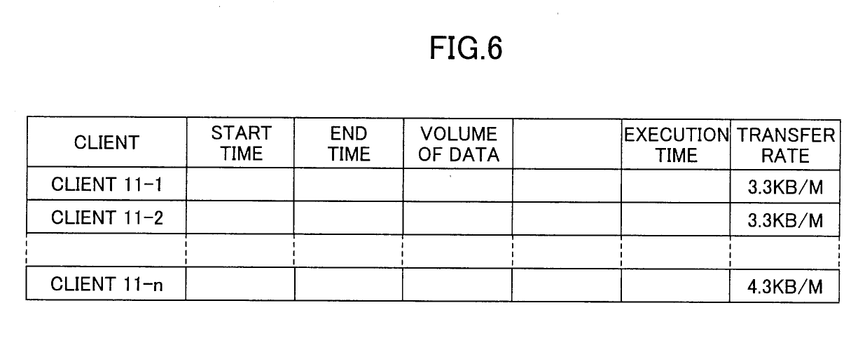

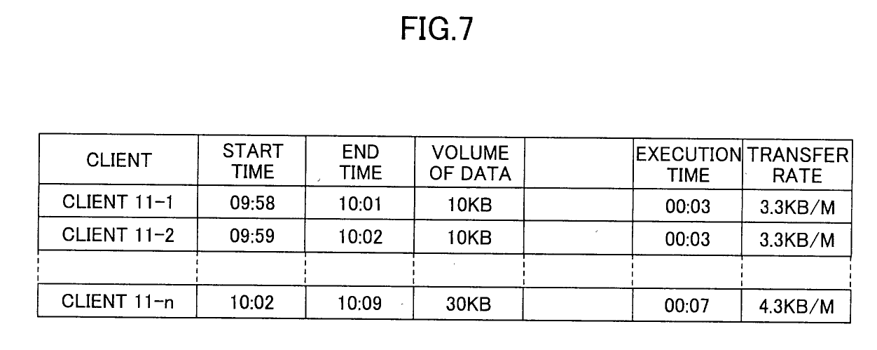

FIG. 6 and FIG. 7 are schematic diagrams of the management tables in the access information storage area 124c. FIG. 6 shows a state before the clients 101-1 through 101-n perform data transfer requests. FIG. 7 shows a state after the clients 101-1 through 101-n perform the data transfer requests.

The access information storage area 124c can store client information, start time information, end time information, volume of data information, execution time information, transfer rate and the like for each of the clients 101-1 through 101-n. The client information is information for identifying the clients 101-1 through 101-n. The start time information is time when the client 101-i performs the data transfer request. The end time information is time when the data transfer to the client 101-i ends. The volume of data information is volume of transfer data to the client 101-i. The execution time information is time taken for the data transfer to the client 101-i. The transfer rate information represents a data transfer rate to the client 101-i and is obtained by dividing the volume of data information by the execution time information.

As shown in FIG. 7, every time the clients 101-1 through 101-n perform a data transfer request, each element of the above-mentioned information is stored in the access information storage area 124c.

Next, a description will be given of an end time estimation process executed by the CPU 122 of the server 102.

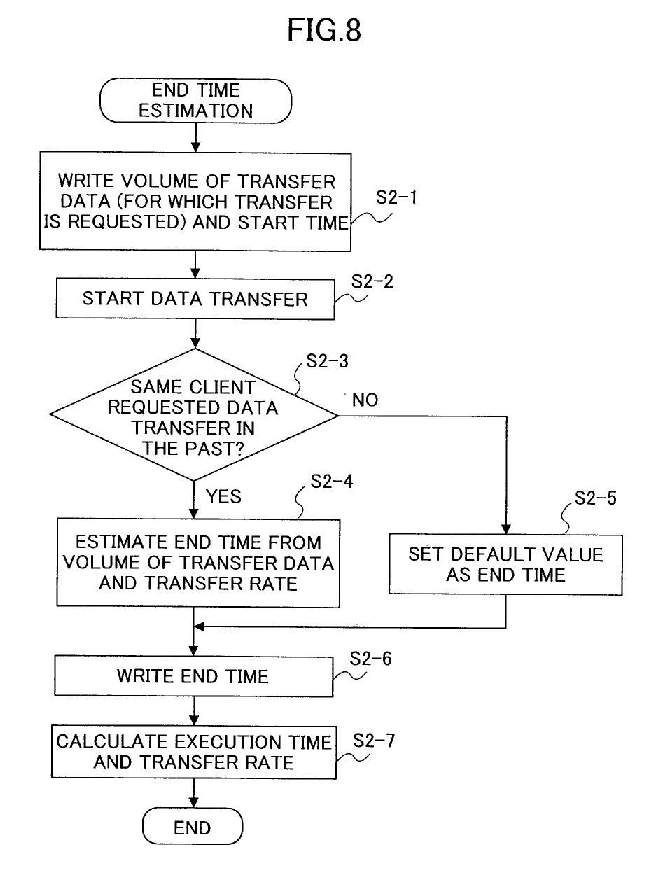

FIG. 8 is a flow chart for explaining the end time estimation process. When the client 101-i accesses the server 102, in step S2-1, the server 102 writes volume of transfer data for which transfer is requested, and start time to the access information storage area 124c. Subsequently, in step S2-2, data transfer is started.

In step S2-3, the server 102 determines whether or not there has been a data transfer request from the client 101-i in the past. When there has been a data transfer request from the client 101-i in the past (YES in step S2-3), the access information storage area 124c stores a transfer rate of transferring data in the past as transfer rate information. Thus, in step S2-4, the server 102 estimates end time based on the transfer rate and the volume of transfer data stored in the access information storage area 124c. The time required for the data transfer is obtained by dividing the volume of transfer data by the transfer rate. The end time is estimated by adding the time required for the data transfer to the start time. Additionally, when there has been no data transfer request from the client 101-i in the past (NO in step S2-3), in step S2-5, the end time is obtained by adding a predetermined default value of the time required for the data transfer to the start time.

When the data transfer to the client 101-i ends, in step S2-6, the server 102 writes the end time obtained in either step S2-4 or S2-5 to the access information storage area 124c. In addition, in step S2-7, execution time is calculated, a transfer rate is obtained by dividing the volume of transfer data by the execution time thereof, and the transfer rate in the access information storage area 124c is updated. The updated value is used for the next time.

When the number of the clients requesting access exceeds processing capacity of the server 102, the next retrying time for each client in excess is obtained from the end time of each of the clients 101-1 through 101-n obtained by the above-mentioned method. Additionally, the next retrying time is provided to the clients 101-1 through 101-n with the NG responses. Thereby, it is possible to provide load sharing of the server 102.

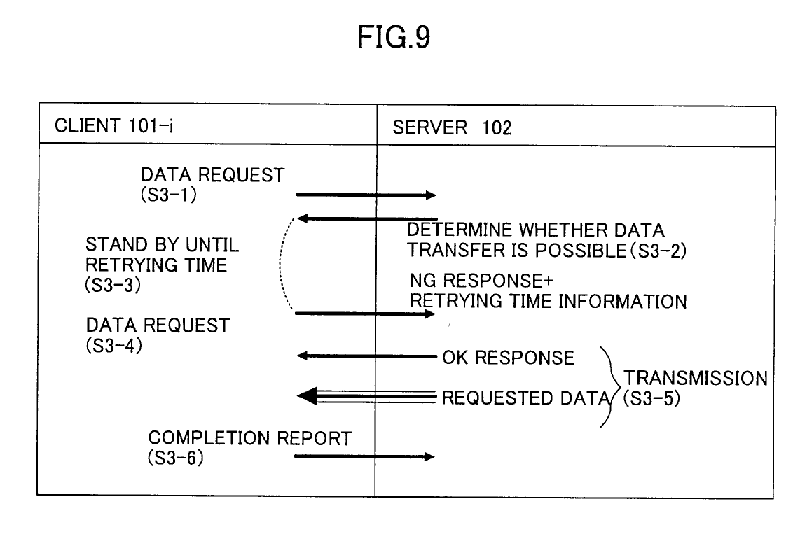

FIG. 9 is a diagram showing a sequence in a case of the NG response of the first embodiment of the present invention.

In step S3-1, the client 101-i sends a data request to the server 102. In step S3-2, the server 102 determines whether or not data transfer is possible. When the number of the clients requesting access exceeds the processing capacity of the server 102, and the data transfer to the client 101-i is impossible, the server 102 transmits an NG response and retrying time information to the client 101-i. The retrying time information is the time when the client 101-i is to perform the data request the next time and is obtained based on the information in the access information storage area 124c. A detailed description will be given later of how to obtain the retrying time information.

When the client 101-i receives the NG response and retrying time information from the server 102, in step S3-3, the client 101-i stands by until the retrying time. In step S3-4, when the retrying time arrives, the client 101-i performs the data request to the server 102 again.

In step S3-5, the server 102 determines whether or not the data transfer is possible. The retrying time is set to a time when the data transfer is possible. Therefore, the server 102 transmits data, which is requested by the client 101-i, with an OK response to the client 101-i. When the client 101-i receives the requested data and OK response, in step S3-6, the client 101-i transmits a completion response to the server 102.

Next, a further detailed description will be given of a process performed by the server 102 in the case of the NG response.

The server 102 manages the number of the clients that are simultaneously connected to the server 102, and estimated end time information based on a simultaneous connection management table chain and a free client management table chain.

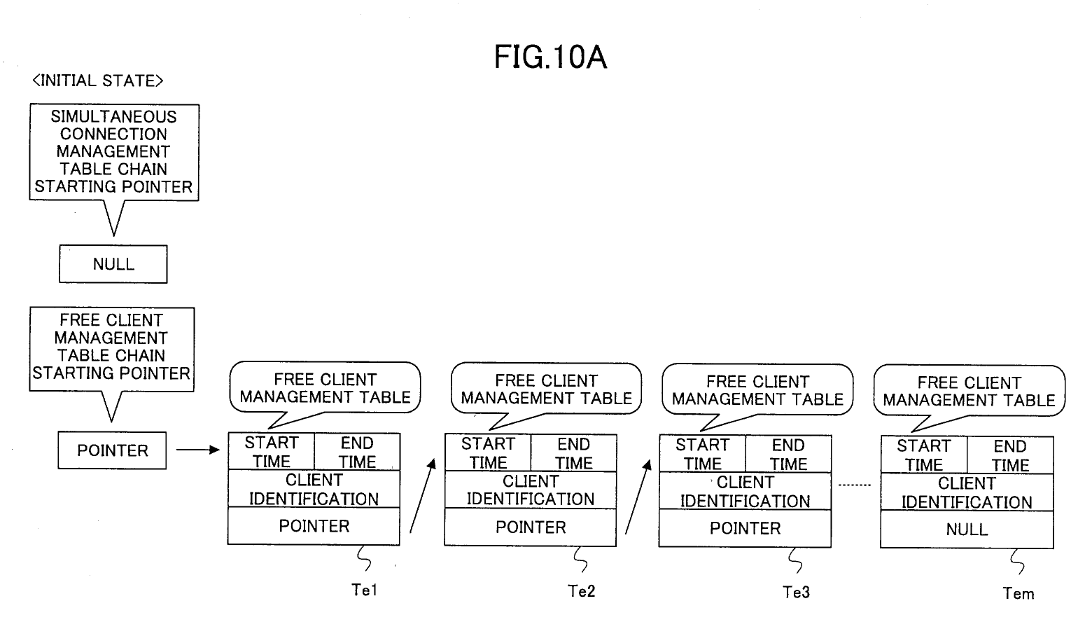

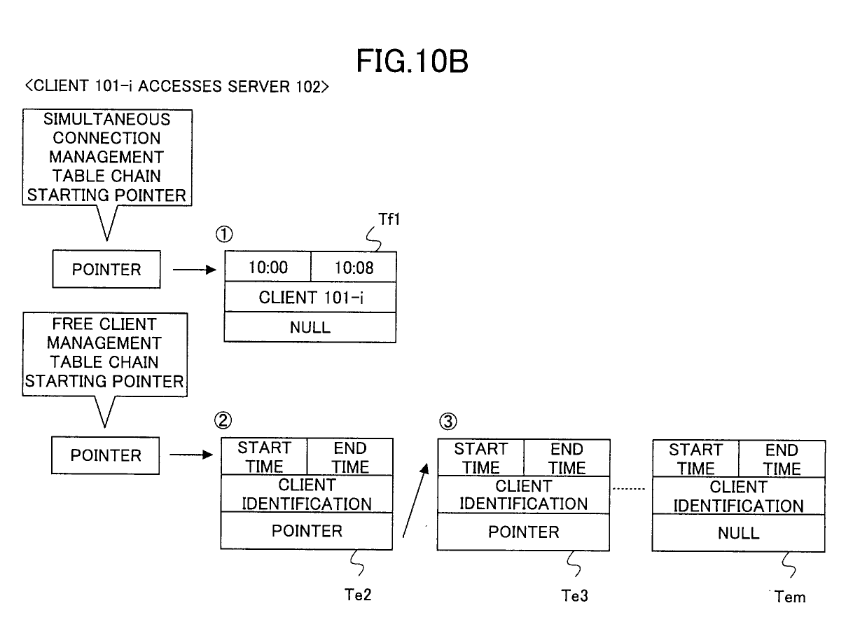

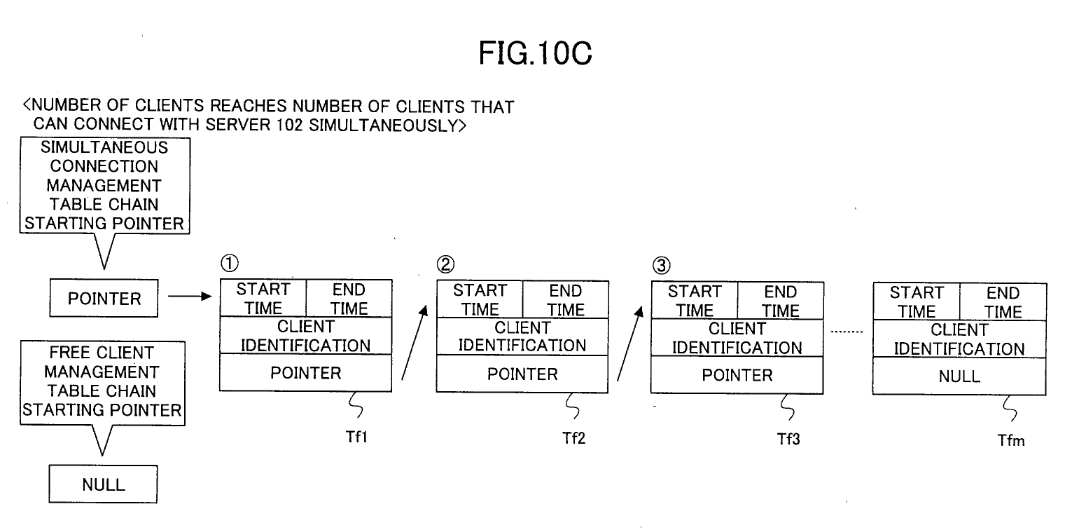

FIGS. 10A, 10B and 10C are schematic diagrams for explaining operations of the simultaneous connection management table chain and free client management table chain. FIG. 10A shows an initial state. FIG. 10B shows a state where the client 101-i accesses the server 102. FIG. 10C shows the simultaneous connection management table chain and free client management table chain in a state in which the number of the clients simultaneously accessing the server 102 reaches the maximum number of clients that can connect with the server 102 simultaneously.

In the initial state, that is, in a state where none of the clients 101-1 through 101-n accesses the server 102, as shown in FIG. 10A, a starting pointer (referred to as “first starting pointer”, hereinafter) of the simultaneous connection management table chain is set as “null”. At this moment, the server 102 has m free client management tables Te1 through Tem corresponding to m clients that can connect with the server 102. Each of the free client management tables Te1 through Tem includes start time information, estimated end time information, client identification information and pointer information.

In the initial state, when the client 101i performs a data request at time “10:00”, data requesting time thereof is obtained as the start time information of the client 101-i. Additionally, estimated end time, “10:08”, for example, is calculated based on the start time information, volume of transfer data information and transfer rate information. Thereby, as shown in FIG. 10B, a simultaneous connection management table Tf1 is created.

At this moment, the first starting pointer of the simultaneous connection management chain is set so as to point to the simultaneous connection management table Tf1. A pointer of the simultaneous connection management table Tf1 is set as “null” since no other client is connected. Additionally, the free client management table Te1 is used as the simultaneous connection management table Tf1. Thus, the number of the free client management tables Te2 through Tem becomes (m−1). A starting pointer (referred to as “second starting pointer”, hereinafter) of the free client management table chain is set so as to point to the free client management table Te2.

As shown in FIG. 10C, when m clients are simultaneously connected to the server 102, a simultaneous connection management table chain including m simultaneous connection management tables Tf1 through Tfm of the m clients is structured. Further, at this moment, the second starting pointer of the free client management table chain is set as “null” since there are no free client management tables remaining.

The server 102 manages the number of the clients, which are simultaneously connected to the server 102, and the estimated end time based on the above-mentioned simultaneous connection management table chain and free client management table chain.

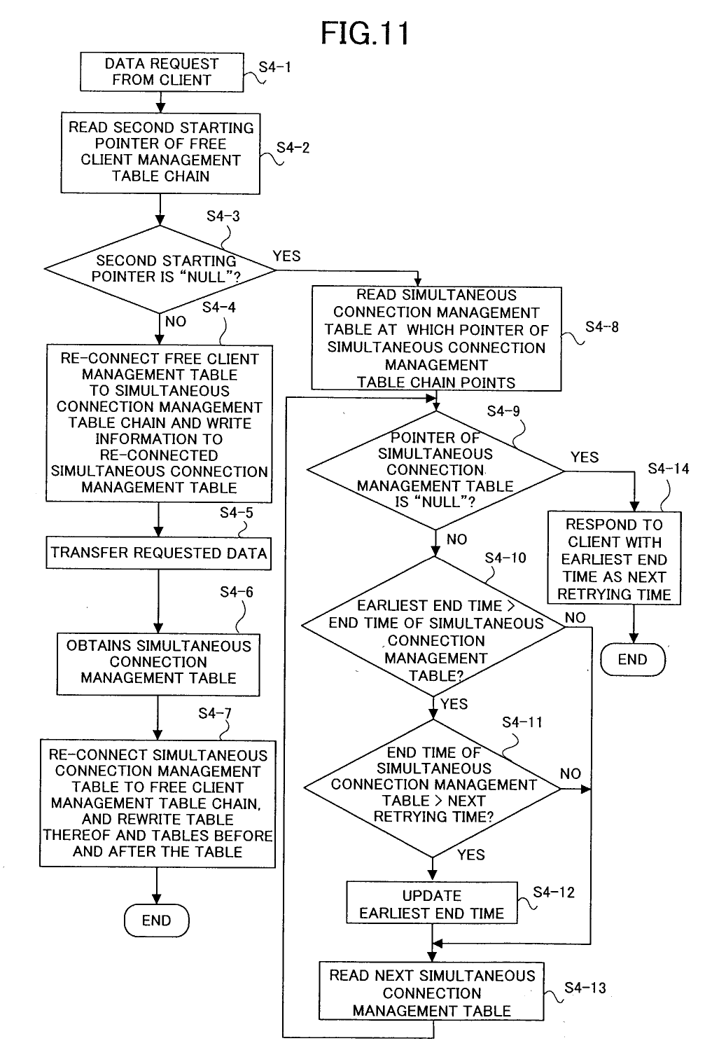

FIG. 11 is a flow chart for explaining operations of the server 102 when the clients send the data requests in the first embodiment of the present invention.

In step S4-1, when the client 101-i sends the data request, in step S4-2, the server 102 reads the second starting pointer of the free client management table chain. Then, in step S4-3, the server 102 determines whether or not the second starting pointer is “null”. In a case where the second starting pointer is not “null” (NO in step S4-3), in a case where a free client management table is still remaining, namely, it is possible for the client 101-i to connect with the server 102. Therefore, in step S4-4, a free client management table Tei is reconnected to the simultaneous connection management table chain. Additionally, the server 102 writes the start time information, estimated end time information, and client identification information of the client 101-i to a simultaneous connection management table Tfi. Thereafter, in step S4-5, the server 102 transfers requested data to the client 101-i.

When the server 102 finishes transferring the requested data to the client 101-i, in step S4-6, the server 102 obtains the simultaneous connection management table Tfi of the client 101-i by sequentially searching the simultaneous connection management table chain from the first starting pointer.

Next, in step S4-7, the simultaneous connection management table Tfi of the client 101-i is removed from the simultaneous connection management table chain and reconnected to the free client management table chain. Additionally, contents of the simultaneous management tables before and after the removed simultaneous connection management table Tfi are rewritten (pointers are updated), and contents of the free client management tables before and after the reconnected free client management table are also rewritten so that both simultaneous connection management table chain and the free client management table chain continue.

Further, in step S4-3, in a case where the second starting pointer is “null” (YES in step S4-3), in a case where the client 101-i cannot connect with the server 102, namely, in step S4-8, the server 102 reads the simultaneous connection management table that the pointer of the simultaneous connection management table chain points to, until the pointer of the simultaneous connection management table becomes “null” in step S4-9. In step S4-9, the server 102 determines whether or not the pointer of the simultaneous connection management table that is read is “null”.

When the pointer of the simultaneous connection management that is read is not “null” (NO in step S4-9), that is, the simultaneous connection management that is read is in the middle (not at the end) of the simultaneous connection management table chain, in step S4-10, the server 102 determines whether or not end time information of the simultaneous connection management table that is read is earlier than an earliest end time that is previously set in the server 102. When the end time information of the simultaneous connection management table that is read is not earlier than the earliest end time (NO in step S4-10), in step S4-13, the server 102 reads a pointer of the next simultaneous connection management table based on the pointer of the current simultaneous connection management table, and returns to step S4-9.

In a case where the end time of the simultaneous connection management table that is read is earlier than the earliest end time (YES in step S4-10), in step S4-11, the server 102 determines whether or not the end time of the simultaneous connection management table is later than next retrying time. When the end time is not later than the next retrying time (NO in step S4-11), the server 102 proceeds to process of step S4-13. When the end time is later than the next retrying time (YES in step S4-11), in step S4-12, the server 102 updates the earliest end time by overwriting the time thereof with the end time thereof, and proceeds to the process of step S4-13.

The steps S4-9 through S4-13 are repeated until the pointer of the simultaneous connection management table becomes “null”. When the pointer becomes “null” (YES in step S4-9), in step S4-14, the server 102 responds to the client 101-i with the earliest end time as the next retrying time.

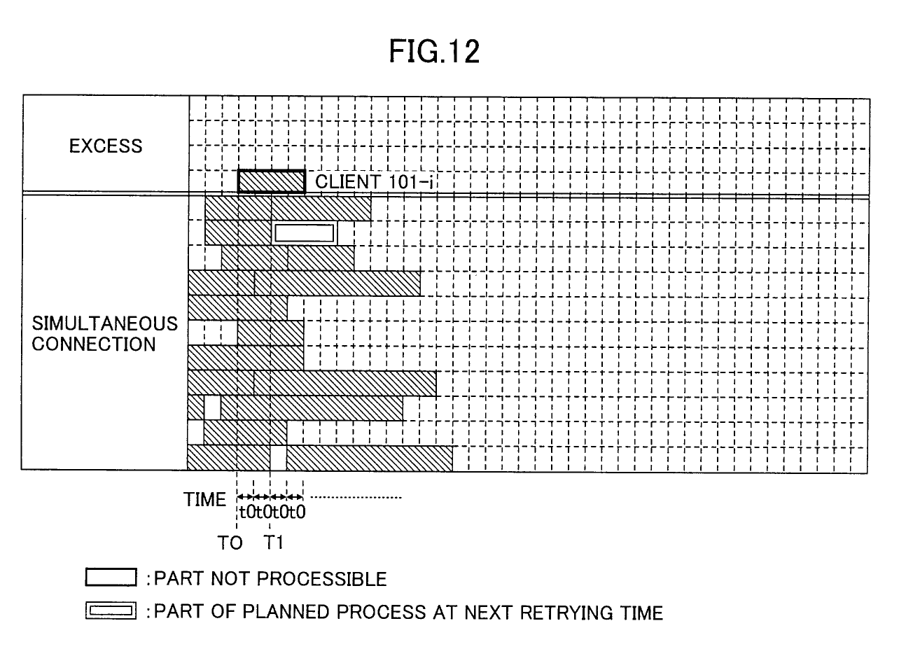

FIG. 12 is a schematic diagram for explaining operations in the case of the NG response in the first embodiment of the present invention. FIG. 12 shows an example when the number of the clients that can simultaneously connect with the server 102 is determined. A horizontal axis represents time, and a vertical axis represents the clients that can simultaneously connect with the server 102. The part above the double lines shows access requests from the clients that exceed the number of the clients that can simultaneously access the server 102.

In a case where any of the clients 101-1 through 101-n sends the data request to the server 102, the server 102 searches for a place available along the vertical axis at that time. When there is a place available, the place is reserved until the estimated time. In FIG. 12, shaded parts represent reserved times. The above-described operation is performed on each of the clients 101-1 through 101-n that sends the data request. In FIG. 12, a client 101-i represents a client that cannot connect with the server 102 when sending the data request at time TO. The next retrying time is obtained by searching for a place available after the time TO by checking at each unit time t0. When the place available is found, time of the place thereof corresponds to the next retrying time. The server 102 responds to the client 101-i with the time found as the next retrying time. In this case, the place surrounded by double lines is available. Thus, the server 102 responds to the client 101-i with time T1 as the next retrying time.

According to this embodiment, connection with the server 102 is reserved. Therefore, it is possible for the client 101-i to positively obtain data when sending the data request again at the next retrying time.

Further, in this embodiment, the server 102 manages such as the start time and end time of the data transfer to the clients 101-1 through 101-n. However, service for the clients 101-1 through 101-n may be balanced such that each of the clients 101-1 through 101-n counts the number of times of retrying after receiving the NG responses when sending the data requests, and the server 102 determines priorities of the data requests from the clients 101-1 through 101-n based on the number of times of retrying.

In the following, a description will be given of an embodiment in which a server determines priorities of data requests from clients based on the number of times of retrying so as to balance service for the clients.

It should be noted that a system structure of this embodiment is the same as that of the first embodiment, except the structures and processes of the clients 101-1 through 101-n and server 102.

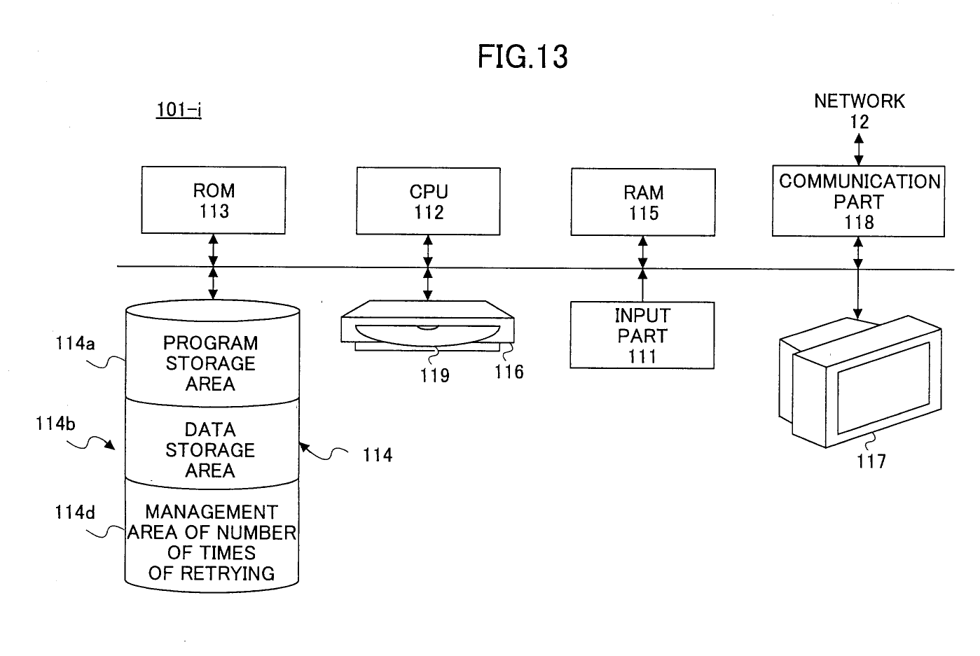

FIG. 13 is a block diagram of a client 101-i in a second embodiment of the present invention. In FIG. 13, those parts that are the same as those corresponding parts in FIG. 4 are designated by the same reference numerals, and a description thereof will be omitted.

Clients 101-1 through 101-n of this embodiment have respective management areas of the number of times of retrying 114d instead of the access information storage areas 114c in hard disk drive 114. The management area of number of times of retrying 114d stores the number of times of retrying. The number of times of retrying stored in the management area of the number of times of retrying 114d is “0” in an initial state, and is increased one by one at every NG response.

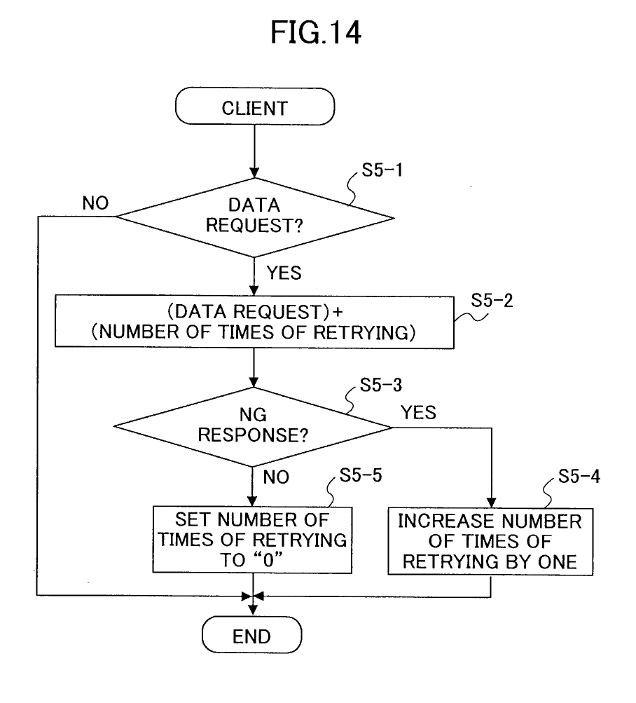

FIG. 14 is a flow chart for explaining a process of each of the clients 101-1 through 101-n of the second embodiment of the present invention.

First, in step S5-1, each of the clients 101-1 through 101-n determines whether or not there is a data request for the server 102. When there is the data request (YES in step S5-1), in step S5-2, the client transmits the data request with the number of times of retrying to the server 102. In step S5-3, the client determines whether or not a response from the server 102 is the NG response. When the response is the NG response (YES in step S5-3), in step S5-4, the client increases the number of times of retrying in the management area of number of times of retrying 114d by one. Additionally, when the response is not the NG response (NO is step S5-3), that is, when the response is the OK response, the client clears the number of times of retrying in the management area of number of times of retrying 114d, sets “0”, namely.

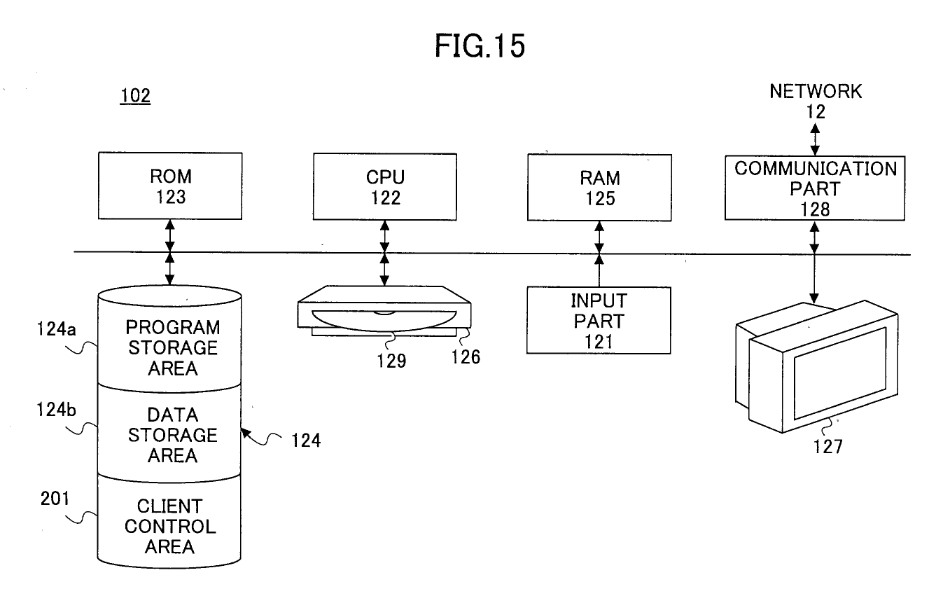

FIG. 15 is a block diagram of the server 102 of the second embodiment of the present invention.

The server 102 of this embodiment has a client control area 201 instead of the access information storage area 124c in the hard disk drive 124.

The server 102 updates a setting of the client control area 201 based on information of the number of times of retrying, which is transmitted with the data requests from the clients 101-1 through 101-n. Additionally, the server 102 controls the processing of the data requests from the clients 101-1 through 101-n according to the settings of the client control area 201.

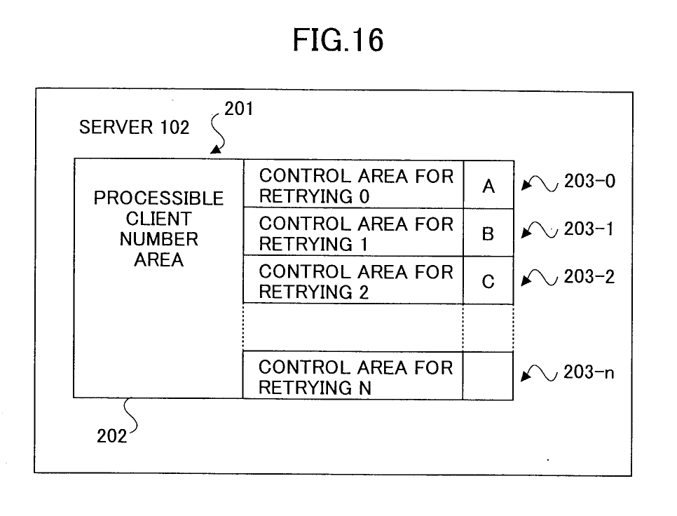

FIG. 16 is a schematic diagram showing a structure of data in the client control area 201.

The client control area 201 includes a client number area 202, control areas 203-0 through 203-n for retrying.

The client number area 202 stores the number of clients that can connect with the server 102 at the moment. A control area 203-0 for retrying stores the number of clients having the number of times of retrying “0”. A control area 203-1 for retrying stores the number of the clients having the number of times of retrying “1”. A control area 203-n for retrying stores the number of clients having the number of times of retrying “n”. The server 102 performs processes, which will be described in the following, according to the client control part 201.

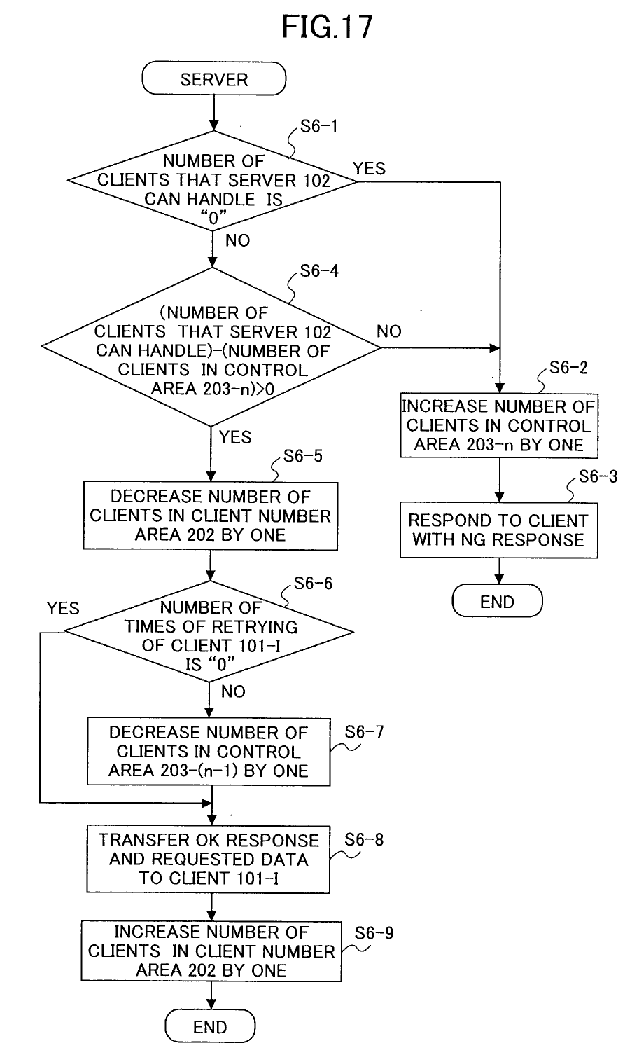

FIG. 17 is a flow chart for explaining processes of the server 102 of the second embodiment of the present invention. In step S6-1, the server 102 determines whether or not the number of the clients that the server 102 can handle is “0”, when there is a data request from the client 101-i as the “n”th retrying. The client 101-i sends the data request to the server 102 by adding information of the number of times of retrying to the data request. When the number of the clients that the server 102 can handle is “0” (YES in step S6-1), in step S6-2, the server 102 increases the number of the clients, which is stored in the control area 203-n for retrying, by one. Then, in step S6-3, the server 102 responds to the client 101-i with the NG response.

Further, when the number of the clients that the server 102 can handle is not “0” (NO in step S6-1), in step S6-4, the server 102 determines whether or not a value obtained by subtracting the number of the clients, which is stored in the control area 203-n, from the number of the clients that the server 102 can handle is greater than “0”. In other words, the server 102 determines whether or not it is possible to handle the client 101-i. In step S6-4, when a value obtained by subtracting the number of the clients stored in the control area 203-n from the number of the clients that the server 102 can handle is not larger than “0” (NO in step S6-4), the server 102 performs steps S6-2 and S6-3.

When the value obtained by subtracting the number of the clients stored in the control area 203-n from the number of the clients that the server 102 can handle is larger than “0” (YES in step S6-4), in step S6-5, the server 102 decreases the number of the clients, which is stored in the client number area 202, by one.

Next, in step S6-6, the server 102 determines whether or not the number of times of retrying of the client 101-i is “0”. When the number of times of retrying is not “0” (NO in step S6-6), in step S6-7, the server 102 decreases the number of the clients stored in a control area 203(n−1) for retrying by one. Then, in step S6-8, the server 102 transfers the OK response and the requested data to the client 101-i. In step S6-9, the server 102 increases the number of the clients, which the server 102 can handle, in the client number area 202 by one.

Additionally, when the number of times of retrying of the client 101-i is “0” (YES in step S66), the process proceeds to step S6-8.

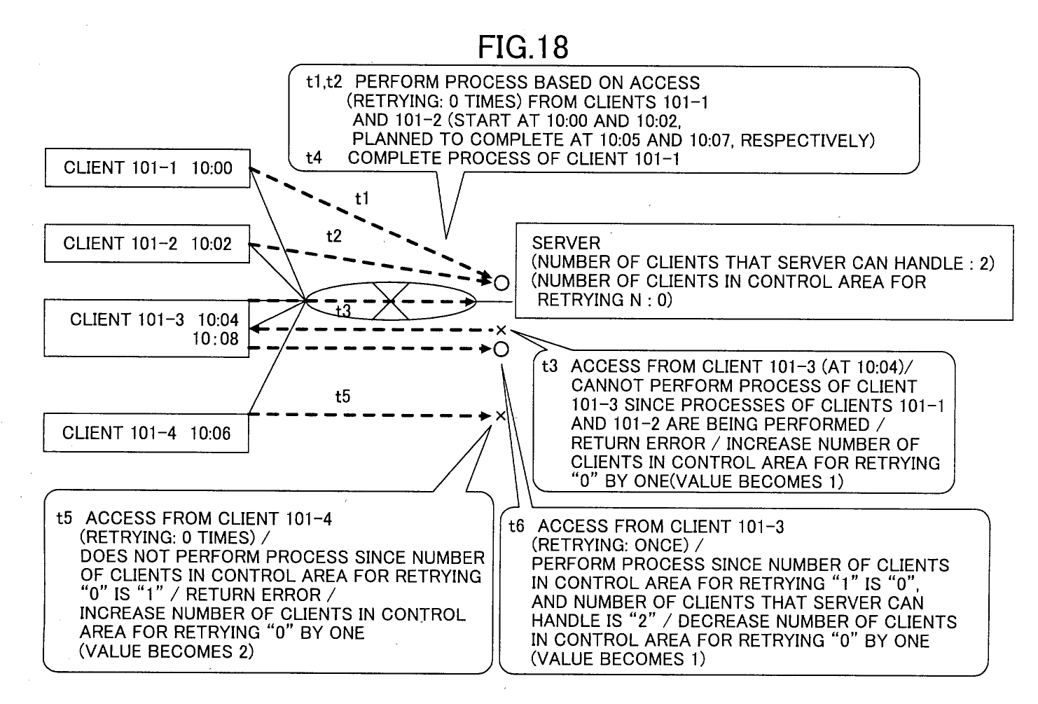

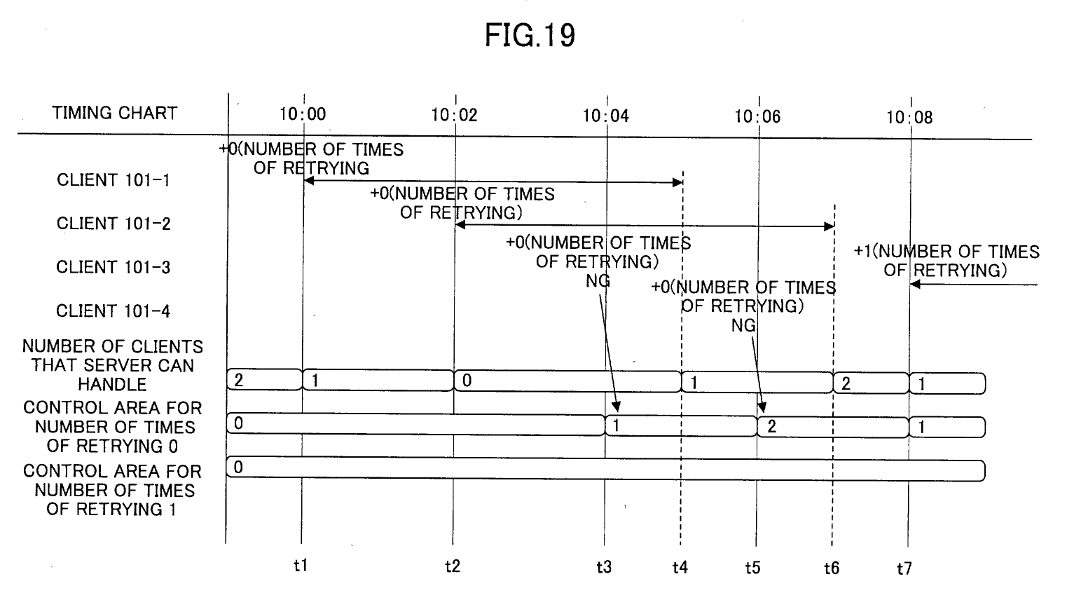

FIGS. 18 and 19 are schematic diagrams for explaining specific operations of the second embodiment. At time t1, the server 102 performs the process based on access by client 101-1. Then, at time t2, the server 102 performs the process based on access by client 101-2.

Next, at time t3, client 101-3 requests to access the server 102. At this moment, when the number of the clients that the server 102 can handle simultaneously is “2”, since two clients, the clients 101-1 and 101-2, are being handled, the server 102 returns an error to the client 101-3. In addition, the server 102 increases number of the clients, which is stored in the control area 203-0 for retrying, by one. Thus, the number of the clients in the control area 203-0 for retrying becomes “1”.

At time t4, when the process of the client 101-1 completes, number of the clients in the client number area 202 becomes “1”, by being increased by one. At time t5, client 101-4 requests to access the server 102 not by retrying. In this case, the number of the clients in the control area 203-0 is “1”, and the client 101-3, which is standing by for the process, exists. Therefore, the server 102 does not perform the process for access by the client 101-4, and returns an error response. Additionally, the server 102 increases the number of the clients in the control area 203-0 by one. Thus, the number of the clients in the control are 203-0 becomes “2”. At time t6, when the process of the client 101-2 completes, the number of the clients in the client number area 202 becomes “2” by being increased by one.

Next, at time t7, when the client 101-3 accesses the server 102 by a first retrying, the number of the clients in a control area 203-1 for retrying is “0”, and no client is standing by for retrying. Further, at this moment, the number of the clients in the client number area 202 is “2”. Thus, the number of the clients that server 102 can handle simultaneously is “2”. Accordingly, the server 102 performs the process corresponding to the access by the client 101-3. Further, the number of the clients in the control part 203-0 becomes “1” by being decreased by one, since the process of the client 101-3 having the number of times of retrying “0” is performed.

Accordingly, it is possible for the server to give priority to a client access with retrying over a client access without retrying.

Further, the load sharing of the server 102 may be performed such that each of the clients 101-1 through 101-n stores a time in a cycle when the request to the server 102 succeeds, and accesses the server 102 at the time thereof in the succeeding cycle.

Next, a description will be given of an embodiment in which each of the clients 101-1 through 101-n stores time in a cycle when the request to the server 102 succeeds, and accesses the server 102 at the same time in a succeeding cycle so that the load sharing of the server 102 is performed.

It should be noted that a system structure of this embodiment is the same as that of the first embodiment, except structures and processes of the clients 101-1 through 101-n. Additionally, the server 102 performs the same process as the conventional server 13.

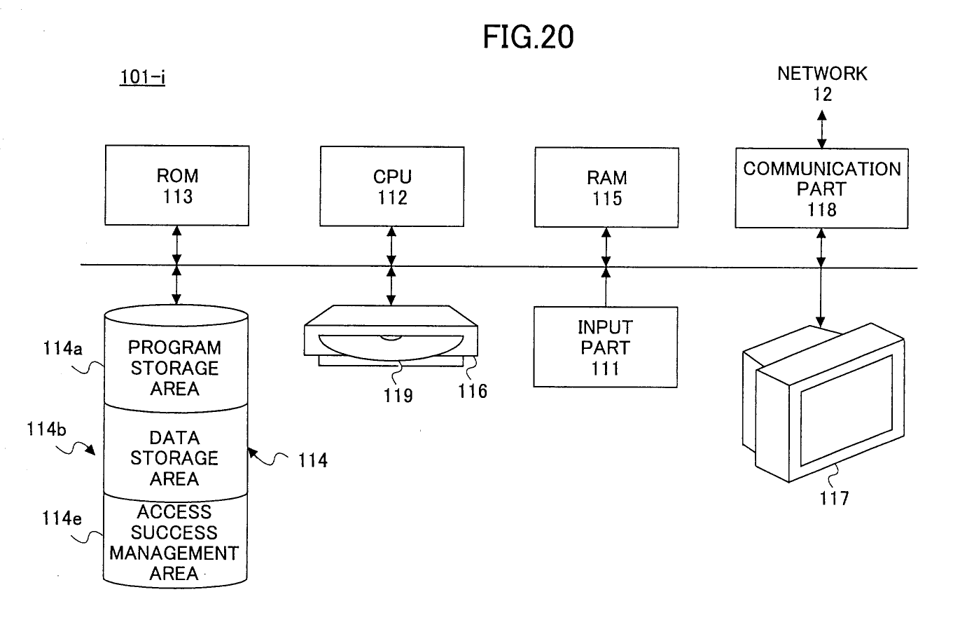

FIG. 20 is a block diagram of a client 101-i of a third embodiment of the present invention. In FIG. 20, those parts that are the same as those corresponding parts in FIG. 4 are designated by the same reference numerals, and a description thereof will be omitted.

The client 101-i of this embodiment has an access success time management area 114e.

In the following, a description will be given of a process of the client 101-i.

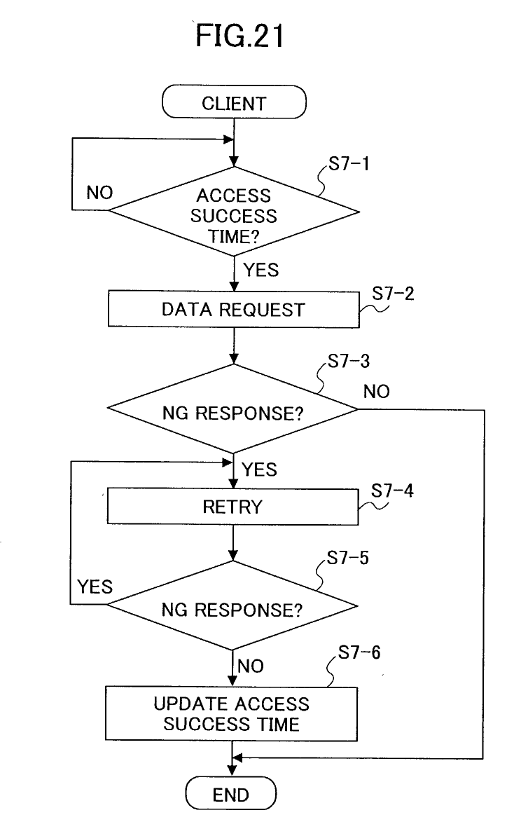

FIG. 21 is a flow chart for explaining the process of the client 101-i of the third embodiment of the present invention. In step S7-1, the client 101-i determines whether or not it is access success time. When it is determined that the access success time, which is stored in the access success management area 114e, has come (YES in step S7-1), in step S7-2, the client 101-i accesses (performs a data request on) the server 102. In step S7-3, the client 101-i determines whether or not a response from the server 102 is an NG response. When the response is not an NG response (NO in step S7-3), that is, when the response is the OK response, the process ends.

In addition, when the response from the server 102 is the NG response (YES in step S7-3), in step S7-4, the client 101-i stands by for a predetermined time, and performs a retrying process of the data request. Then, in step S7-5, the client 101-i determines whether or not the response from the server 102 is the NG response.

When the response from the server 102 is the NG response (YES in step S7-5), the process returns to step S7-4 and the client 101-i performs the retrying process again. When the response from the server 102 is the OK response (NO in step S7-5), in step S7-6, the client 101-i stores retrying time thereof in the access success management area 114e so as to update the access success time, and the process ends. Thereby, in the next time of accessing, the client 101-i accesses the server 102 at the same access success time in a succeeding cycle.

Next, a description will be given of operation of the third embodiment using a specific example.

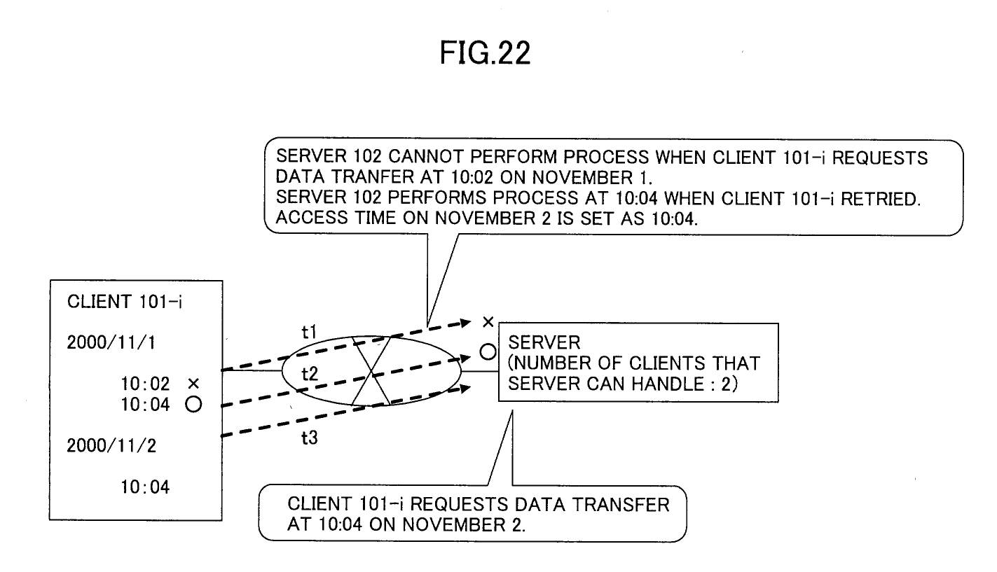

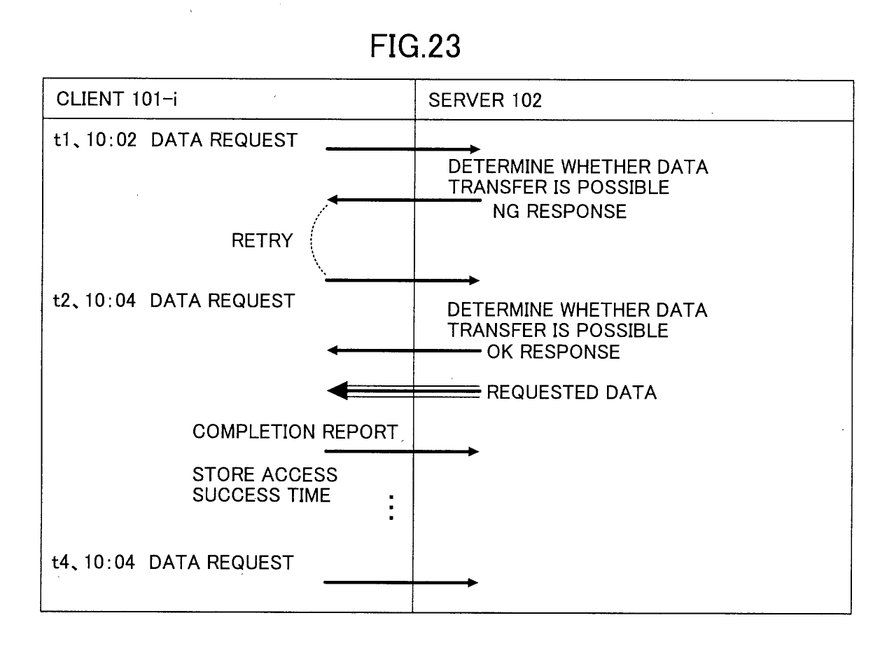

FIGS. 22 and 23 are schematic diagrams for explaining the specific example of the third embodiment.

At time t1 (10:02), the client 101-i performs a data transfer request on the server 102. At this moment, the server 102 determines whether or not it is possible to perform the data transfer. In this case, it is assumed that a response of the server 102 is the NG response.

For the NG response from the server 102, the client 101-i performs retrying at time t2 (10:04). At this time, the server 102 gives the OK response to the client 101-i, and transfers the requested data to the client 101-i.

When the transfer ends, the client 101-i stores time t3 (10:04), when connection with the server 102 succeeded, in the access success management area 114e.

When time t3 (10:04), which is stored in the access success management area 114e, has come again for the next time (in the next cycle)(time t4), the client 101-i accesses (performs a data request on) the server 102.

According to this embodiment, it is possible to perform the load sharing of the server 102 merely by changing the process of the clients 101-1 through 101-n.

Further, when it is necessary for the clients 101-1 through 101-n to perform retrying in a time frame in which gaining access is impossible, retrying time may be set again randomly so as to prevent the retrying in the time frame.

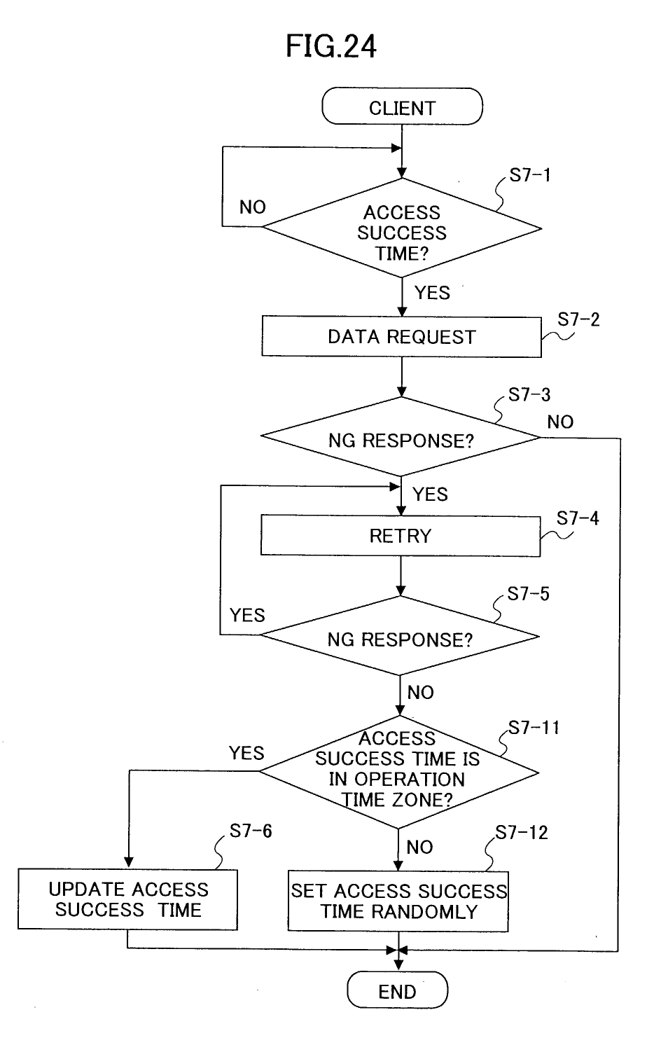

FIG. 24 is a flow chart for explaining a modification of the process of the client 101-i of the third embodiment of the present invention. In FIG. 24, those steps that are the same as those corresponding steps in FIG. 21 are designated by the same reference numerals, and a description thereof will be omitted.

In this embodiment, when the response from the server 102 is not the NG response (NO in step S7-5), that is, when the response is the OK response, in step S7-11, the client 101-i determines whether or not time when the retrying succeeds is in an operation time frame. When the time is in the operation time frame (YES in step S7-11), in step S7-6, the client 101-i stores the time when the retrying succeeds in the access success management area 114e as the access success time so as to update the previous access success time. Additionally, in a case where the time when the retrying succeeds is not in the operation time frame (NO in step S7-11), in step S7-12, the client 101-i stores a time, which is selected randomly, in the access success management area 114e, as the access success time.

In the following, a description will be given of specific operation of this modification, with reference to the drawings.

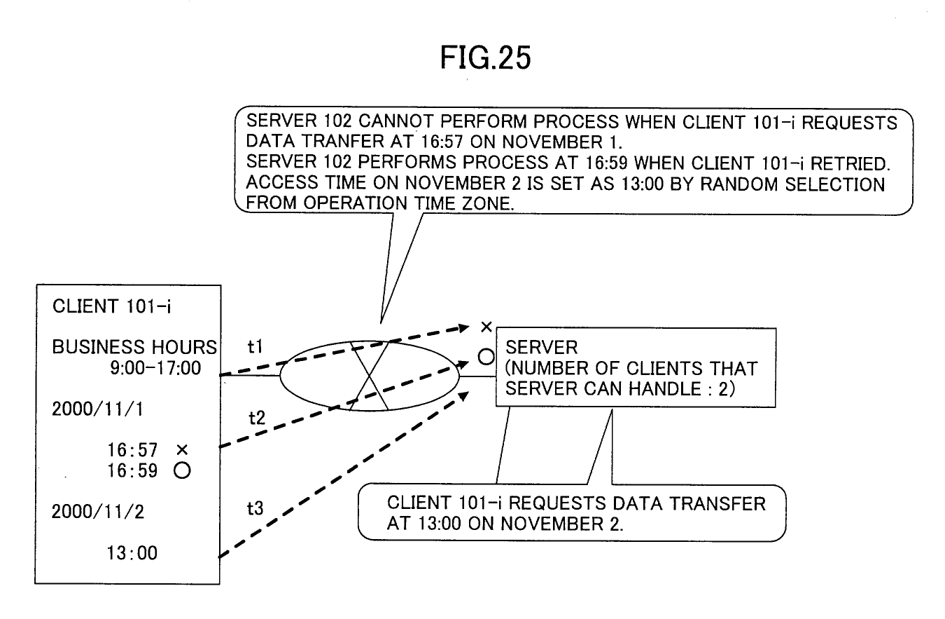

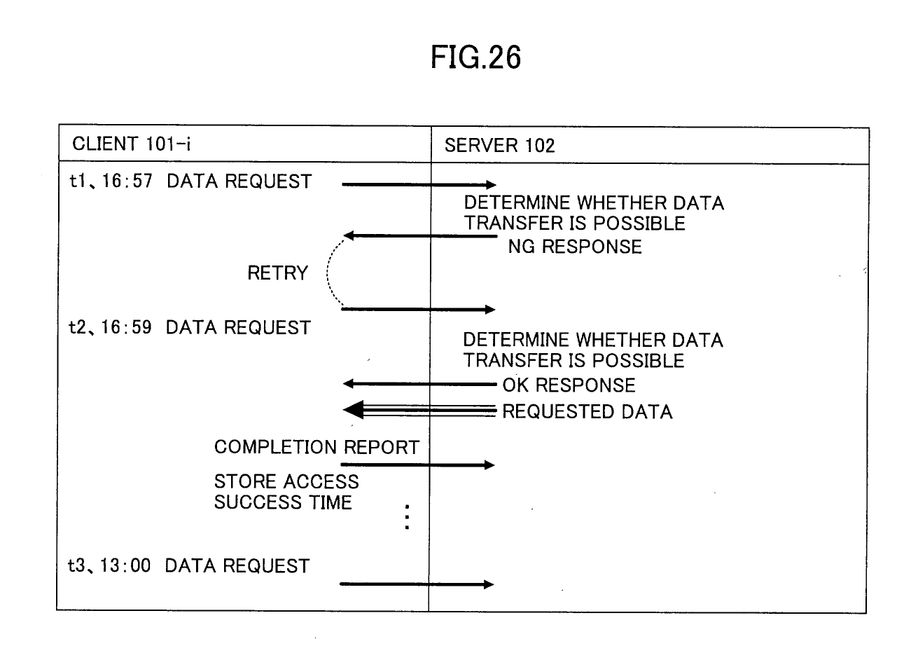

FIGS. 25 and 26 are schematic diagrams for explaining the operation of the modification of the third embodiment of the present invention. First, at time t1 (16:57), a client 101-i performs a data transfer request on the server 102. Then, the server 102 determines whether or not it is possible to perform the data transfer, and gives the NG response to the client 101-i.

The client 101-i performs retrying at time t2 (16:59). The server 102 receives the data request in the retrying.

When the transfer ends, the client 101-i determines whether or not the time t2 (16:59), when access to the server 102 succeeded, is in the operation time frame. The operation time frame is included in business hours, and end time of the operation time frame is set one hour earlier than ending time of the business hours, for example. When the time t2 is not in the operation time frame, access time is randomly selected, and the access success management area 114e is rewritten. For example, in this case, the access management area 114e is rewritten to time t3 (13:00).

According to this embodiment, it is possible to perform the data request in a future cycle at the time when the access succeeded in the operation time frame that is previously set.

Further, in a case where data in the server 102 is updated, it is possible to perform the load sharing of the server 102 such that the server 102 makes out a schedule of the data requests from the clients 101-1 through 101-n beforehand, and notifies the clients of the schedule.

Next, a description will be given of an embodiment in which, in a case where data in the server 102 is updated, the load sharing of the server 102 is performed such that the server 102 makes out a schedule of requests from the clients 101-1 through 101-n beforehand, and notifies the clients of the schedule.

A system structure of this embodiment is the same as that of the first embodiment, except for the process of the clients 101-1 through 101-n and a structure and process of the server 102, and a description thereof will be omitted.

In this embodiment, a data resource, which is common to the clients 101-1 through 101-n, is stored in the server 102. The load sharing is performed when the server 102 changes the data resource, and the clients 101-1 through 101-n all together perform the data transfer requests at the next access.

First, a description will be given of a structure of the server 102.

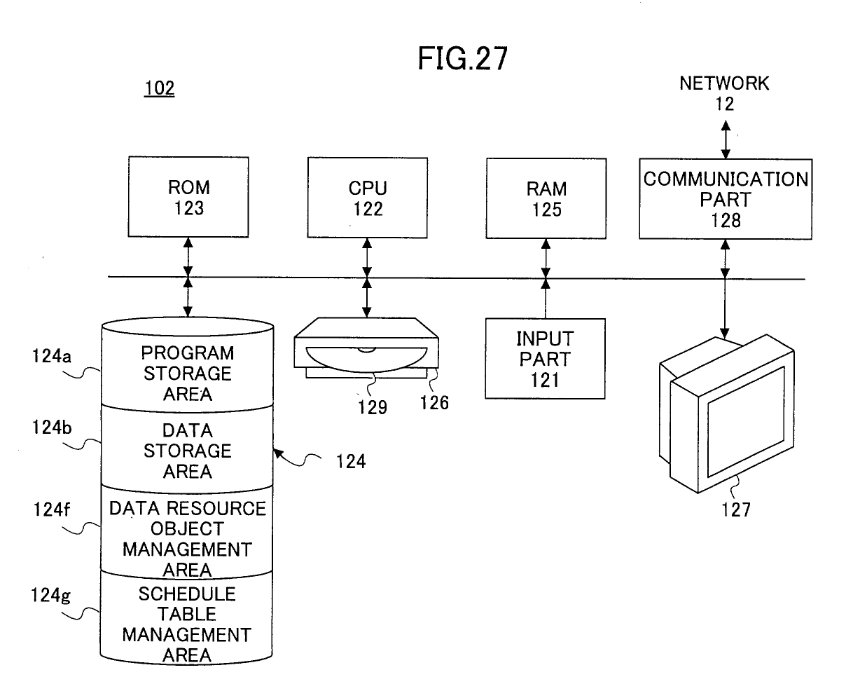

FIG. 27 is a block diagram of the server 102 of a fourth embodiment of the present invention. In FIG. 27, those parts that are the same as those corresponding parts in FIG. 5 are designated by the same reference numerals, and a description thereof will be omitted.

The server 102 of this embodiment has a data resource object management area 124f and a schedule table management area 124g instead of the access information storage area 124c.

The data resource object management area 124f is a table containing the data resource and the clients that refer to the data resource, such that the data resource corresponds to the clients. The schedule table management area 124g stores an access schedule of the clients that refer to the data resource and are influenced by change of the data resource.

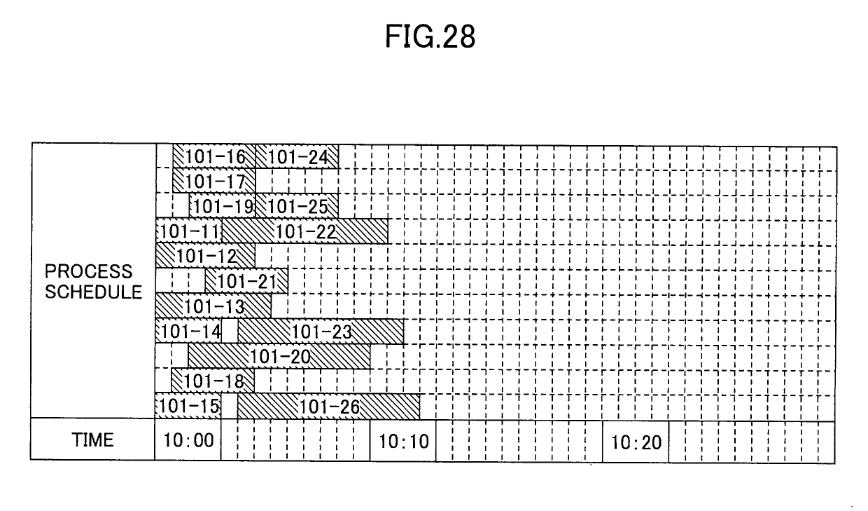

FIG. 28 is a schematic diagram showing a structure of data in the schedule table management area 124g.

The schedule table management area 124g stores a process schedule table of the server 102. The process schedule table has, as shown in FIG. 28, a structure in which access time of clients 101-11 through 101-26, which are influenced by the change of the data resource among the clients 101-1 through 101-n, is set.

First, a description will be given of an entire process flow of the fourth embodiment of the present invention.

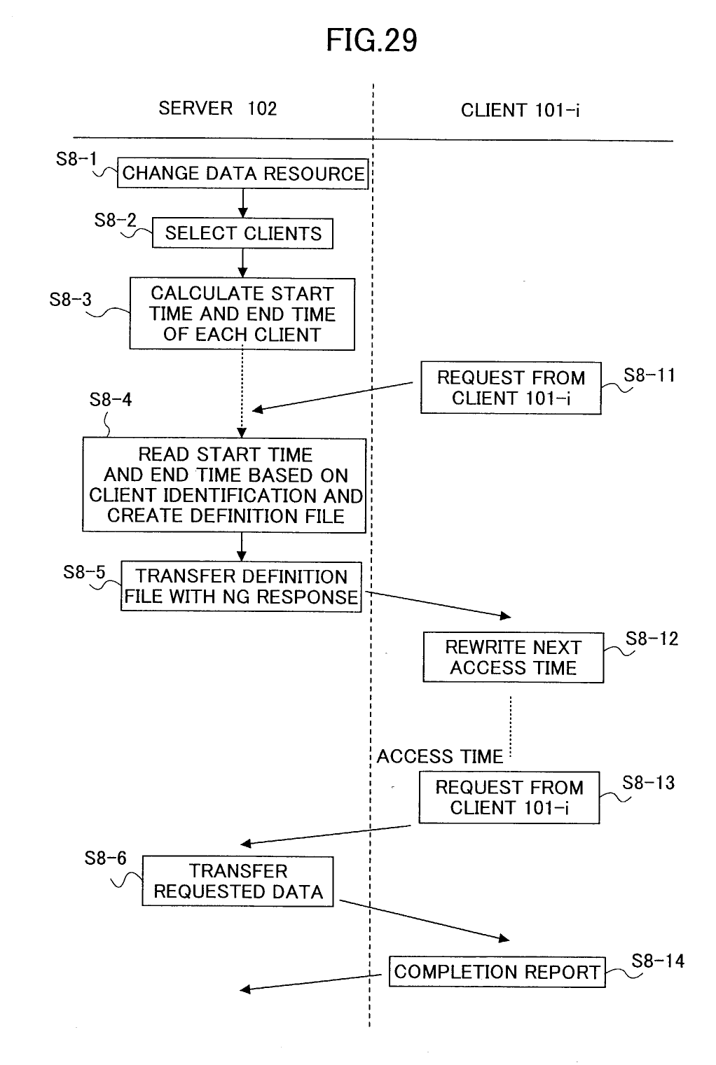

FIG. 29 is a flow chart for explaining a process of the fourth embodiment of the present invention. In step S8-1, when the data resource is changed, in step S8-2, the server 102 selects the clients that are influenced by the change of the data resource based on the data resource object management area 124f.

In step S8-3, start time and end time of each of the clients, which are selected in step S8-2, are calculated.

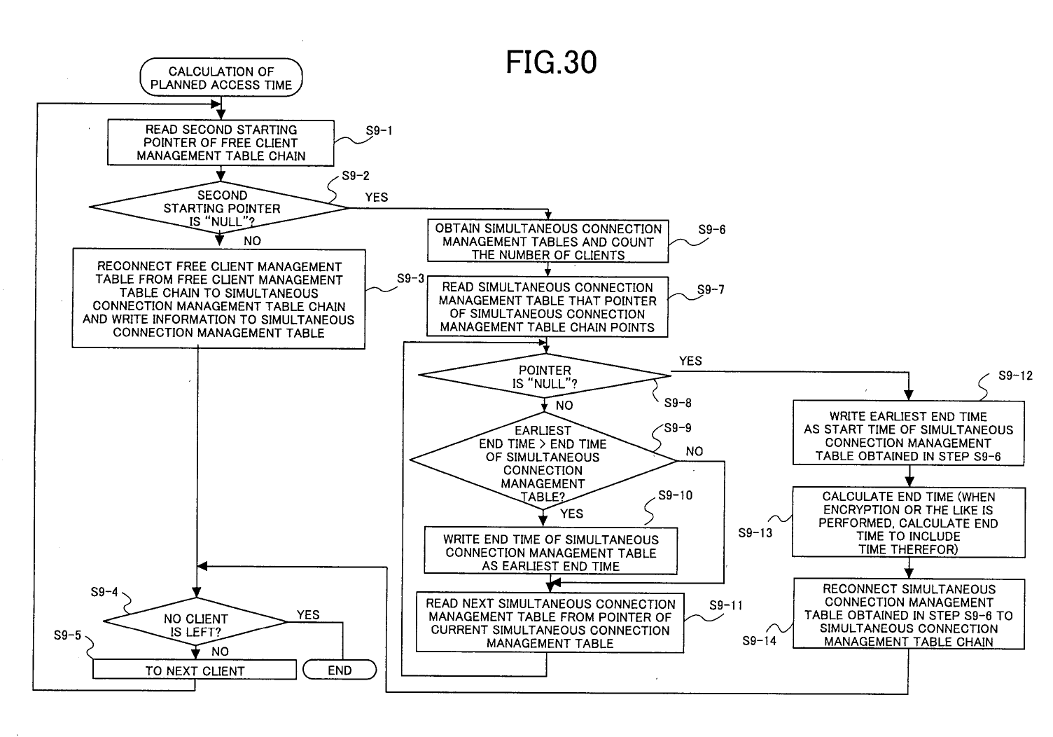

FIG. 30 is a flow chart for explaining process of calculating the start time and end time of the clients.

When the clients, which are influenced by the change of the data resource, are selected, in step S9-1, the server 102 reads the second starting pointer of the free client management table chain. Then, in step S9-2, the server 102 determines whether or not the second starting pointer is “null”. When the second starting pointer is not “null” (NO in step S9-2), that is, when a free client management table exists, it is possible to connect the selected client 101-i. Thus, in step S9-3, the server 102 reconnects a free client management table Tei to the simultaneous connection management table chain, and writes start time information, estimated end time information and identification information of the client 101-i to a reconnected simultaneous connection management table Tfi. Next, in step S9-4, the server 102 determines whether or not the client, which is influenced by the change of the data resource, remains. When the client remains (NO in step S9-4), in step S9-5, the client becomes a next target of the process. Then, the process returns to step S9-1.

Additionally, when the second starting pointer is “null” (YES in step S9-2), in step S9-6, the server 102 searches the simultaneous connection management table chain in sequence from the first starting pointer, and obtains the simultaneous connection management tables of the selected clients in sequence. Further, the server 102 counts the number of the simultaneous connection management tables that are obtained, the number of the clients, namely.

Next, in step S9-7, the server 102 obtains a pointer by reading the simultaneous connection management table that is obtained. In step S9-8, the server 102 determines whether or not the pointer of the simultaneous connection management table is “null”.

When the pointer, which is read from the simultaneous connection management table, is not “null” that indicates there is no simultaneous connection management table left in the simultaneous connection management table chain, that is, when the simultaneous connection management table chain continues (NO in step S9-8), in step S9-9, the server 102 determines whether or not the end time stored in the simultaneous connection management table is earlier than the earliest end time detected until then. When the server 102 determines that the end time of the simultaneous connection management table is earlier than the earliest end time (detected until then) (YES in step S9-9), in step S9-10, the server 102 sets the end time of the simultaneous connection management table as the earliest end time.

Next, in step S9-11, the server 102 reads the next simultaneous connection management table from the pointer of the current simultaneous connection management table. Then, the process returns to step S9-8. The process of steps S9-8 through S9-11 is repeated until the pointer of the simultaneous connection management table becomes “null”. When the pointer of the simultaneous connection management table becomes “null” (YES in step S9-8), in step S9-12, the server 102 writes the earliest end time that is set in step S9-10 to the simultaneous connection management table that is obtained in step S9-6 as the start time.

In step S9-13, the server 102 estimates end time of the simultaneous connection management table, which is obtained in step S9-6, from volume of data, a transfer rate and start time. The end time is obtained such that the volume of data is divided by the transfer rate, and a result thereof is added to the start time, for example. Next, in step S9-14, the server 102 reconnects the simultaneous connection management table, which is obtained in step S9-6, to the simultaneous connection management table chain. The process continues by returning to step S9-4.

By repeating the above-mentioned process, as shown in FIG. 28, the schedule table in which no client receives the NG response can be created.

Here, returning to FIG. 29, a description will be given of the process of the fourth embodiment after step S8-3.

When the schedule table as shown in FIG. 28 is created in step S8-3, the server 102 waits for a data request from the client 101-i. In step S8-11, when the client 101-i sends the data request, in step S8-4, the sever 102 extracts the start time and end time of the client 101-i from the schedule table, which has been already created, and creates a definition file. In step S8-5, the server 102 transfers the definition file, which is created in step S8-4, with an NG response to the client 101-i.

Next, in step S8-12, the client 101-i updates next access time to the time defined in the definition file.

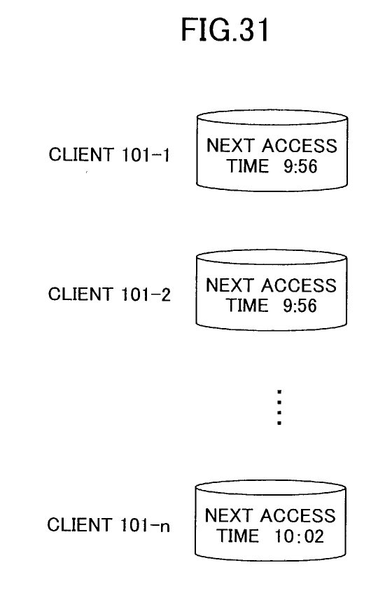

FIG. 31 is a schematic diagram showing the next access time that is set to each of the clients 101-1 through 101-n.

For example, the next access time, which is defined by the server 102, is set to the access information storage area 114c of each of the clients 101-1 through 101-n as shown in FIG. 31.

In step S8-13, the client 101-i performs the data request on the server 102 when the next access time has arrived.

In step S8-6, when the server 102 receives the data request from the client 101-i, the server 102 transfers the requested data to the client 101-i. At this moment, the request from the client 101-i is on the schedule table, and the server 102 is in a state where the process (data transfer) is possible. Accordingly, the requested data can be transferred without the NG response.

In step S8-14, when the client 101-i completes receiving the requested data, the client 101-i transmits a completion report to the server 102 and the process ends.

According to this embodiment, the server 102 receives requests from the clients 101-1 through 101-n according to the schedule table that is previously determined. Therefore, it is possible for the clients 101-1 through 101-n to receive necessary data without receiving the NG responses repeatedly. Additionally, the server 102 can effectively perform the process according to the schedule table.

Further, in step S8-3 of this embodiment, when creating the schedule table as shown in FIG. 28, the end time may be estimated by taking data attributes into consideration, for example, time required for encryption and the like.

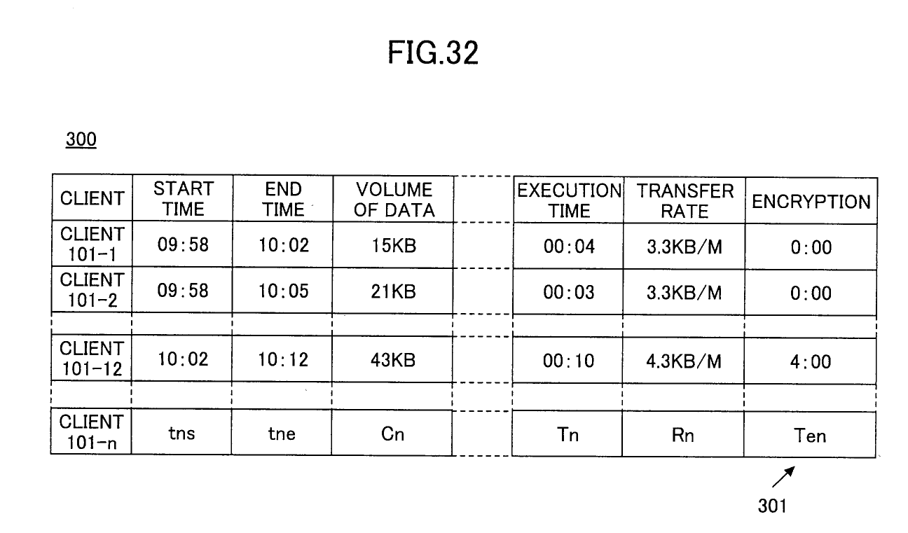

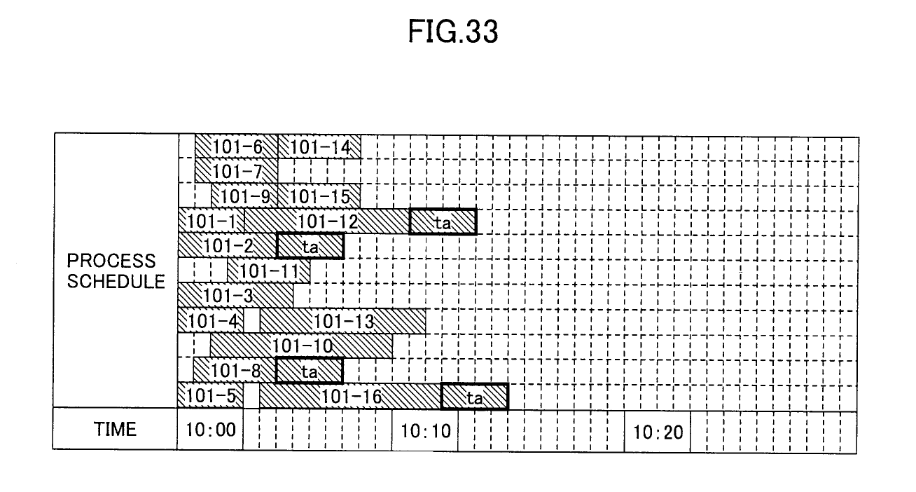

FIG. 32 is a schematic diagram showing a data structure of a management table 300. FIG. 33 is a schematic diagram showing another schedule table. In FIGS. 32 and 33, those parts that are the same as those corresponding parts in FIGS. 6 and 28, respectively, are designated by the same reference numerals, and a description thereof will be omitted.

The management table 300 of this embodiment includes a data attribute 301. The data attribute 301 is time of encryption, for example, as shown in FIG. 32. When creating the schedule table as shown in FIG. 33 based on the management table 300, each end time of the schedule table is obtained such that encryption time ta of the data attribute 301 is added to each end time of the management table.

Thereby, it is possible to accurately estimate the end time since the end time can be estimated by taking time, which is consumed based on the data attribute 301, such as the encryption time ta, into consideration.

The present invention is not limited to the specifically disclosed embodiments, and variations and modifications may be made without departing from the scope of the present invention.

The present application is based on Japanese priority application No. 2002-003538 filed on Jan. 10, 2002, the entire contents of which are hereby incorporated by reference.

What is claimed is:

1. A system in which clients send data transfer requests to a server, and the server transmits data to the clients according to the data transfer requests, wherein the server comprising:
an access management part that creates access information representing an access state of the clients based on the data transfer requests from the clients, and manages access by the clients to the server based on the access information.

2. The system as claimed in claim 1, wherein the server further comprising:
an access information reporting part that creates next access information based on the access information stored in the access management part, and reports the next access information to the clients.

3. The system as claimed in claim 2, wherein the clients access the server based on the next access information from the server.

4. The system as claimed in claim 1, wherein the server manages number of times of requesting access as the access information, and controls permission for the access requests by the clients based on the number of times of requesting access.

5. The system as claimed in claim 1, wherein the access information corresponds to start time when the clients start accessing to the server, end time when the access ends, and process time thereof.

6. A system in which clients sends data transfer requests to a server, and the server transmits data to the clients according to the data transfer requests, wherein the clients set at least next access time to time when access to the server has succeeded.

7. The system as claimed in claim 6, wherein the clients randomly set access time subsequent to the next access time in a case where access has ended in failure at the next access time.

8. A system in which clients send data transfer requests to a server, and the server transmits data to the clients according to the data transfer requests, wherein the server selects a client to access, sets access time of the client so as not to transmit a negative response, and notifies the client of the access time that is set, and the client accesses the server at the access time that is notified by the server.

9. The system as claimed in claim 8, wherein the server compensates the access time according to data attributes that are previously set to data transmitted to the clients.

10. An apparatus that transmits data to clients according to data transfer requests from the clients, comprising:
an access management part that creates access information representing an access state of the clients based on the data transfer requests from the clients, and controls access by the clients so as to distribute the access by the clients based on the access information.

11. The apparatus as claimed in claim 10, wherein the access management part prepares next access time of the clients based on the access information, and notifies the clients of the next access time.

12. An apparatus that sends a data transfer request to a server, and causes the server to transfer data corresponding to the data transfer request, comprising:
an access management part that sets next access time to time when access to the server has succeeded.

13. The apparatus as claimed in claim 12, wherein the access management part randomly sets access time subsequent to the next access time in a case where access to the server has ended in failure at the next access time.

14. An apparatus that transmits data to clients according to data transfer, requests from the clients, comprising:
an access management part that selects a client for which data transfer should be performed, sets access time of the selected client so as not to transfer a negative response, and notifies the client of the access time that is set.

15. The apparatus as claimed in claim 14, wherein the access management part compensates the access time when the clients access the server according to data attributes that are previously set to data transmitted from the server to the clients.

16. An access distributing method of a system in which clients send data transfer requests to a server, and the server transmits data to the clients according to the data transfer requests, wherein access information representing an access state of the clients is created based on the data transfer requests from the clients, and access by the clients to the server is controlled to be distributed based on the access information.

17. The access distributing method as claimed in claim 16, wherein next access time of the clients is prepared based on the access information, and the clients are notified of the next access time.

18. The access distributing method as claimed in claim 17, wherein the clients are caused to access the server at the next access time.

19. An access distributing method of a system in which clients send data transfer requests to a server, and the sever transmits data to the clients according to the data transfer requests, wherein time when access to the server has succeeded is set as next access time of the clients.

20. The access distributing method as claimed in claim 19, wherein access time subsequent to the next access time is randomly set in a case where the clients have failed in accessing the server at the next access time.

21. An access distributing method of a system in which clients send data transfer requests to a server, and the server transmits data to the clients according to the data transfer requests, wherein the clients on which data transfer should be performed are selected, access time of the selected clients is set so as not to transfer negative responses, and the clients are notified of the access time that is set, and the clients are caused to access the server at the access time that is notified by the server.

22. The access distributing method as claimed in claim 21, wherein the access time when the clients access the server is compensated according to data attributes that are previously set to data transmitted from the server to the clients.

23. A method to be carried out by the operation of a server, comprising the steps of:
causing the server to create access information representing an access state of clients based on data transfer requests from the clients; and
controlling access by the clients so as to distribute the access by the clients based on the access information.

24. The method as claimed in claim 23, wherein next access time of the client is prepared based on the access information, and the client is notified of the next access time.

25. A method to be carried out by the operation of a server in a system in which clients send data transfer requests to a server, and the server transmits data to the clients according to the data transfer requests, wherein time when access to the server has succeeded is set as next access time of the clients.

26. The method as claimed in claim 25, wherein access time subsequent to the next access time is randomly set in a case where the access to the server has ended in failure at the next access time.

27. A method to be carried out by the operation of a server, comprising the steps of:
selecting clients to which data transfer should be performed;
setting access time of the selected clients so as not to transfer a negative response; and
notifying the clients of the access time that is set.

28. The method as claimed in claim 27, wherein the access time when the clients access the server is compensated according to data attributes that are previously set to data transmitted from the server to the clients.
